(19) United States
(12) Patent Application Publication
(10) Pub. No.: US 2023/0246786 A1
(43) Pub. Date: Aug. 3, 2023

(54) DATA RECEPTION METHOD, DATA TRANSMISSION METHOD AND APPARATUSES THEREOF

(71) Applicant: FUJITSU LIMITED, Kawasaki-shi (JP)

(72) Inventors: Guorong LI, Beijing (CN); Meiyi JIA, Beijing (CN); Pengyu JI, Beijing (CN); Zhe CHEN, Beijing (CN); Lei ZHANG, Beijing (CN)

(73) Assignee: FUJITSU LIMITED, Kawasaki-shi (JP)

(21) Appl. No.: 18/133,092

(22) Filed: Apr. 11, 2023

Related U.S. Application Data
(63) Continuation of application No. PCT/CN2020/120904, filed on Oct. 14, 2020.

(51) Int. Cl. H04L 5/00; H04W 48/12

(52) U.S. Cl. CPC H04L 5/0053; H04W 48/12

(57) ABSTRACT

An apparatus, applicable to a terminal equipment, includes a receiver configured to receive first indication information, the first indication information being used for indicating first configuration information of a first control resource set, a processor configured to determine second configuration information of a second control resource set of the terminal equipment according to the first indication information or a synchronization signal block (SSB) to which the first control resource set corresponds, and monitor, on resources of the second control resource set, monitor a physical downlink control channel used for receiving a physical downlink shared channel where system information is located.

### CROSS-REFERENCE TO RELATED APPLICATION

This application is a continuation application of International Application PCT/CN2020/120904 filed on Oct. 14, 2020 and designated the U.S., the entire contents of which are incorporated herein by reference.

### TECHNICAL FIELD

This disclosure relates to the field of communication technologies.

### BACKGROUND

In the fifth generation (5G) communication technology, service transmission may be performed between network devices and terminal equipments. For example, such services may include but are not limited to: enhanced mobile broadband (eMBB), massive machine type communication (mMTC), and high-reliable and low-latency communication (URLLC), etc.

In addition, 5G may also support use cases in many vertical industries, such as devices in industrial environments (such as industrial network wireless sensors) connected to 5G wireless access and core networks, and data transmission of surveillance cameras and wearable devices in smart city innovation, including smart watches, bracelets, health related devices and medical monitoring devices, etc.

Characteristics of the above use cases are that device costs and complexities are lower than those of high-end eMBB and URLLC devices of current standard versions, especially industrial network wireless sensors. Furthermore, requirements on most use cases are that standard designs need to support devices with relatively small sizes, low service rate requirements, and specific use cases require that devices have relatively long battery lives.

At present, the 3rd Generation Partnership Project (3GPP) supports studies of characteristics and parameters of a reduced capability (RedCap) terminal equipment (hereinafter referred to as a UE). The RedCap UE may cover the terminal equipments in the above three use cases, and has lower end capabilities than the eMBB and URLLC in the current standard version.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY

At present, a UE needs to perform cell search and obtain synchronization signal blocks (SSBs) during initial access to a network to obtain a master information block (MIB). The MIB includes configuration of a physical downlink control channel (PDCCH) related to system information block1 (SIB1), the configuration including control resource set 0 (CORESET #0) configuration and search space 0 (SS #0) configuration, and a terminal equipment determines PDCCH monitoring occasions according to the control resource set 0 and search space 0, and monitors a PDCCH at the monitoring occasions, and obtains SIB1 according to physical downlink shared channel (PDSCH) information indicated by the PDCCH. Configuration information of an initial downlink bandwidth part (initial BWP) is included in SIB1, and the terminal equipment may use the initial downlink bandwidth part to perform reception of subsequent PDSCHs or PDCCHs.

3GPP agreed that for initial access in frequency range 2 (FR2), the maximum bandwidth supported by the RedCap UE can be 50 MHz and 100 MHz. The inventor found that when the maximum bandwidth capability of the RedCap UE is 50 MHz, for the scenario where the RedCap UE and other UEs other than the RedCap UE coexist, the control resource set 0 and/or the initial downlink bandwidth part may be greater than 50 MHz, which exceeds the reception capability of the RedCap UE, This will cause the RedCap UE to not correctly receive the control information and/or data in the control resource set 0 and/or the initial downlink bandwidth.

In order to solve at least one of the above problems, embodiments of this disclosure provide a data reception method, data transmission method and apparatuses thereof.

According to an aspect of the embodiments of this disclosure, there is provided a data reception apparatus, applicable to a terminal equipment, the apparatus including:

a first receiving unit configured to receive first indication information, the first indication information being used for indicating first configuration information of a first control resource set;

a first determining unit configured to determine second configuration information of a second control resource set of the terminal equipment according to the first indication information or a synchronization signal block (SSB) to which the first control resource set corresponds; and

a first monitoring unit configured to, on resources of the second control resource set, monitor a physical downlink control channel used for receiving a physical downlink shared channel where system information is located.

According to another aspect of the embodiments of this disclosure, there is provided a data reception apparatus, applicable to a terminal equipment, the apparatus including:

a fifth determining unit configured to receive fourth indication information and fifth indication information transmitted by a network device, the fourth indication information being used to indicate first related information of a first initial bandwidth part (BWP), and the fifth indication information being used to indicate second related information of a second initial bandwidth part (BWP); and

a fourth receiving unit configured to receive a downlink channel and/or signal in the second initial bandwidth part indicated by the fifth indication information.

According to a further aspect of the embodiments of this disclosure, there is provided a data transmission apparatus, applicable to a network device, the apparatus including:

a first transmitting unit configured to transmit indication information, the indication information being used for indicating first configuration information of a first control resource set or being used for indicating third configuration information of a first search space, and the indication information or a synchronization signal block (SSB) corresponding to the first control resource set being used to determine second configuration information of a second control resource set of a terminal equipment, or the indication information being used to determine fourth configuration information of a second search space of the terminal equipment; and

a second transmitting unit configured to, on a resource of the second control resource set or in the second search space, transmit a physical downlink control channel used for the terminal equipment to receive a physical downlink shared channel where system information is located.

An advantage of the embodiments of this disclosure exists in that by determining the location and/or size of the control resource set and/or search space and/or initial BWP bandwidth of the terminal equipment for receiving the downlink control channel and/or data channel by direct indication or implicit determination, the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/includes” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is schematic diagram of a communication system of an embodiment of this disclosure;

FIG. 2 is a schematic diagram of the data reception method of an embodiment of this disclosure;

FIG. 3 is a schematic diagram of a reception bandwidth supported by an Redcap UE and a bandwidth of a first control resource set of the embodiment of this disclosure;

FIG. 4A and FIG. 4B are schematic diagrams of two correspondences between a location of the first control resource set and a location of a second control resource set of the embodiment of this disclosure;

FIG. 5 is a schematic diagram of the data reception method of an embodiment of this disclosure;

FIG. 6 is a schematic diagram of a correspondence of frequency-domain location between an SSB and a second control resource set of the embodiment of this disclosure;

FIG. 7 is another schematic diagram of the data reception method of the embodiment of this disclosure;

FIG. 8 is a further schematic diagram of the data reception method of the embodiment of this disclosure;

FIG. 9 is still another schematic diagram of the data reception method of the embodiment of this disclosure;

FIG. 10 is a schematic diagram of initial BWP configuration of the embodiment of this disclosure;

FIG. 11 is yet another schematic diagram of the data reception method of the embodiment of this disclosure;

FIG. 12 is further still another schematic diagram of the data reception method of the embodiment of this disclosure;

FIG. 13 is a yet further schematic diagram of the data reception method of the embodiment of this disclosure;

FIG. 14 is a schematic diagram of the data transmission method of an embodiment of this disclosure;

FIG. 15 is another schematic diagram of the data transmission method of the embodiment of this disclosure;

FIG. 16 is a further schematic diagram of the data transmission method of the embodiment of this disclosure;

FIG. 17 is still another schematic diagram of the data transmission method of the embodiment of this disclosure;

FIG. 18 is yet another schematic diagram of the data transmission method of the embodiment of this disclosure;

FIG. 19 is further still another schematic diagram of the data transmission method of the embodiment of this disclosure;

FIG. 20 is yet further schematic diagram of the data transmission method of the embodiment of this disclosure;

FIG. 21 is yet further another schematic diagram of the data transmission method of the embodiment of this disclosure;

FIG. 22 is a schematic diagram of the data reception apparatus of an embodiment of this disclosure;

FIG. 23 is another schematic diagram of the data reception apparatus of the embodiment of this disclosure;

FIG. 24 is a further schematic diagram of the data reception apparatus of the embodiment of this disclosure;

FIG. 25 is still another schematic diagram of the data reception apparatus of the embodiment of this disclosure;

FIG. 26 is yet another schematic diagram of the data reception apparatus of the embodiment of this disclosure;

FIG. 27 is further still another schematic diagram of the data reception apparatus of the embodiment of this disclosure;

FIG. 28 is yet further another schematic diagram of the data reception apparatus of the embodiment of this disclosure;

FIG. 29 is a schematic diagram of the data transmission apparatus of an embodiment of this disclosure;

FIG. 30 is another schematic diagram of the data transmission apparatus of the embodiment of this disclosure;

FIG. 31 is a further schematic diagram of the data transmission apparatus of the embodiment of this disclosure;

FIG. 32 is still another schematic diagram of the data transmission apparatus of the embodiment of this disclosure;

FIG. 33 is yet another schematic diagram of the data transmission apparatus of the embodiment of this disclosure;

FIG. 34 is yet still another schematic diagram of the data transmission apparatus of the embodiment of this disclosure;

FIG. 35 is further still another schematic diagram of the data transmission apparatus of the embodiment of this disclosure;

FIG. 36 is a schematic diagram of the network device of an embodiment of this disclosure; and

FIG. 37 is a schematic diagram of the terminal equipment of an embodiment of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G and 5G and new radio (NR) in the future, etc., and/or other communication protocols that are currently known or will be developed in the future.

In the embodiments of this disclosure, the term “network device”, for example, refers to a device in a communication system that accesses a terminal equipment to the communication network and provides services for the terminal equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, which may be expressed as a serving cell, and may be a macro cell or a pico cell, depending on a context of the term.

In the embodiments of this disclosure, the term “user equipment (UE)” or “terminal equipment (TE) or terminal equipment” refers to, for example, an equipment accessing to a communication network and receiving network services via a network device. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or a core network device, and may include one or more network devices described above. The term “user side” or “terminal side” or “terminal equipment side” refers to a side of a user or a terminal, which may be a UE, and may include one or more terminal equipments described above. “Device” may refer to a network device, or may refer to a terminal equipment.

In the embodiments of this disclosure, “allow”, “not barred” and “support” may be interchangeable in use, and “not allowed”, “barred” and “not support” may be interchangeable in use.

Scenarios in the embodiments of this disclosure shall be described below by way of examples; however, this disclosure is not limited thereto.

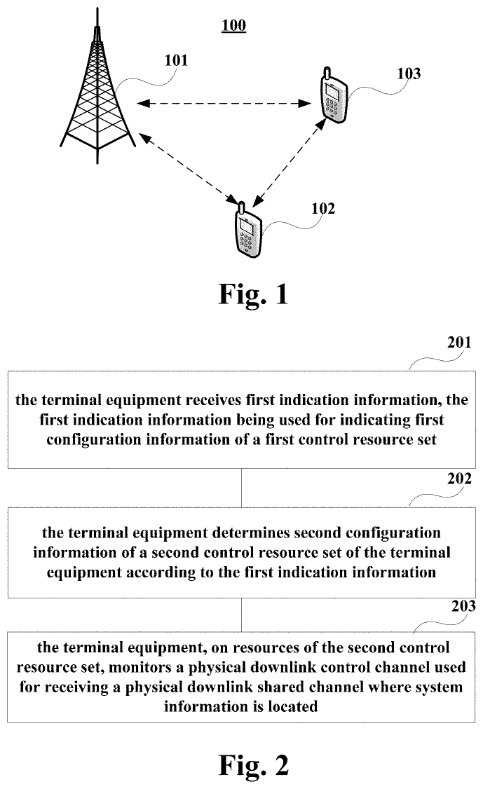

FIG. 1 is a schematic diagram of a communication system of an embodiment of this disclosure, in which a case where terminal equipments and a network device are taken as examples is schematically shown. As shown in FIG. 1, the communication system 100 may include a network device 101 and terminal equipments 102, 103. For the sake of simplicity, an example having only two terminal equipments and one network device is schematically given in FIG. 1; however, the embodiments of this disclosure is not limited thereto.

In the embodiments of this disclosure, existing services or services that may be implemented in the future may be performed between the network device 101 and the terminal equipments 102, 103. For example, such services may include but not limited to an enhanced mobile broadband (eMBB), massive machine type communication (mMTC), ultra-reliable and low-latency communication (URLLC), and related communications of reduced capability terminal equipments, etc.

It should be noted that FIG. 1 shows that two terminal equipments 102, 103 are both within coverage of the network device 101. However, this disclosure is not limited thereto, and the two terminal equipments 102, 103 may not be within the coverage of the network device 101, or one terminal equipment 102 is within the coverage of the network device 101 and the other terminal equipment 103 is outside the coverage of the network device 101.

Following description shall be given with reference to various embodiments.

### Embodiments of a First Aspect

The embodiments of this disclosure provide a data reception method, which shall be described from a side of a terminal equipment.

FIG. 2 is a schematic diagram of the data reception method of the embodiment of this disclosure. As shown in FIG. 2, the method includes:

201: the terminal equipment receives first indication information, the first indication information being used for indicating first configuration information of a first control resource set;

202: the terminal equipment determines second configuration information of a second control resource set of the terminal equipment according to the first indication information; and

203: the terminal equipment, on resources of the second control resource set, monitors a physical downlink control channel used for receiving a physical downlink shared channel where system information is located.

It should be noted that FIG. 2 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 2.

In some embodiments, the first control resource set is control resource set 0 (coreset #0 or coreset index 0 or coreset ID 0), wherein control resource set 0 refers to a control resource set configured for a common search space of a PDCCH of type 0, the common search space of the PDCCH of type 0 being used to transmit a PDCCH scheduling a PDSCH where system information is transmitted, that is, the PDCCH is used to schedule the PDSCH, and the PDSCH carries the system information. For example, the system information may be system information type 1 (SIB1). In order to distinguish from a second control resource set 0 described later, the first control resource set 0 represents an existing control resource set 0 configured by a network device for a terminal equipment, such as a control resource set 0 used by a related terminal equipment in receiving a PDCCH of a PDSCH where an SIB is located. The related terminal equipment may be another terminal equipment than an RedCap UE or a terminal equipment with a related bandwidth capability (for example, the bandwidth capability is greater than or equal to 100 MHz).

In some embodiments, the first indication information is included in a master information block (MIB) to indicate first configuration information of the first control resource set. For example, the network device may preconfigure a first table or predefine the first table. The first table includes a correspondence between the first indication information and the first configuration information of the first control resource set. The first indication information may be a row index of the first table or an index of the first configuration information. After receiving the first indication information, the terminal equipment may determine the first configuration information indicated by the first indication information by looking up the table. The first configuration information includes at least one of a pattern multiplexed by the synchronization signal block and the first control resource set, frequency-domain bandwidth information, time-domain length information, and the first offset value of the frequency-domain between the first control resource set and the synchronization signal block. For example, the frequency-domain bandwidth information may be the number of resource blocks (RBs) in the first control resource set 0, the time-domain length information may be the number of OFDM symbols in the first control resource set 0, and the first offset value may be an offset value between a minimum RB index of a control resource set and an index of a first RB of an SSB corresponding to the control resource set.

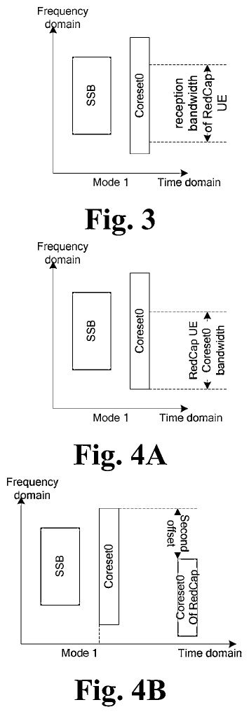

In some embodiments, the terminal equipment may be a terminal equipment with a smaller bandwidth capability (such as less than or equal to 50 MHz), such as an Redcap UE supporting 50 MHz bandwidth, wherein the smaller bandwidth is less than the first control resource set. FIG. 3 is a schematic diagram of a reception bandwidth supported by the Redcap UE and a bandwidth of the first control resource set. As shown in FIG. 3, the reception bandwidth supported by the Redcap UE is less than the bandwidth of the first control resource set, hence, the terminal equipment may possibly be unable to receive a PDCCH in the first control resource set.

In some embodiments, the terminal equipment determines second configuration information of the second control resource set of the terminal equipment according to the first indication information, such as determining the second configuration information according to the first configuration information indicated by the first indication information, the second configuration information including information of the same type as the first configuration information, or, according to the first configuration information, the terminal equipment determines information indicating a time frequency domain location of the second control resource set, such as information indicating a frequency-domain starting or ending or central location of the second control resource set. The second control resource set is the control resource set 0 (control resource set 0 or CORESET #0 or CORESET index 0 or CORESET ID 0, etc.), i.e. control resource set 0 used for the terminal equipment to monitor a PDCCH of a PDSCH where the SIB1 locates. Hence, the terminal equipment does not monitor the PDCCH of the PDSCH where the system information is received on a bandwidth of the first control resource set, so as to avoid a problem that a PDCCH is unable to be correctly received due to insufficient bandwidth capability, which shall be described below in detail.

In some embodiments, the terminal equipment determines that there is a correspondence between the frequency-domain location of the second control resource set and the frequency-domain location of the first control resource set indicated by the first indication information, for example, the terminal equipment determines the frequency-domain starting or ending or central location of the first control resource set according to the first indication information, and takes the frequency-domain starting or ending or central location of the first control resource set as the frequency-domain starting or ending or central location of the second control resource set; or, takes a location obtained by performing offset on the frequency-domain starting, or ending or central location of the first control resource set by a second offset value as a frequency-domain starting, or ending or central location of the second control resource set. The second offset value may be an offset value between RB indices, or an offset value between sub-channel indices, or an offset value between RE (resource element) indices, etc.

For example, the frequency-domain starting or ending or central location may be represented by a resource block index, that is, a minimum RB index (starting location) of the first control resource set is taken as a minimum RB index (starting location) of the second control resource set; or, a maximum RB index (ending location) of the first control resource set is taken as a maximum RB index (ending location) of the second control resource set; or, a central RB index (central location) of the first control resource set is taken as a central RB index (central location) of the second control resource set; or, a location obtained by performing offset on a minimum RB index (starting location) of the first control resource set by the second offset value is taken as a minimum RB index (starting location) of the second control resource set; or, a location obtained by performing offset on a maximum RB index (ending location) of the first control resource set by the second offset value is taken as a maximum RB index (ending location) of the second control resource set; or, a location obtained by performing offset on a central RB index (central location) of the first control resource set by the second offset value is taken as a central RB index (central location) of the second control resource set. For another example, the frequency-domain starting or ending or central location may also be represented by a sub-channel index or a resource element (RE) index, etc., which is similar to representing by the resource block index, and shall not be described herein any further.

In some embodiments, determining the frequency-domain starting or ending or central location of the first control resource set according to the first indication information, that is to determine the minimum RB index, the maximum RB index or the central RB index of the first control resource set according to the first indication information. For example, the minimum RB index of the first control resource set may be determined according to a first offset value to which the first indication information corresponds and the frequency-domain starting location of the SSB, and the maximum RB index or central RB index may be determined according to the minimum RB index and the number of RBs in the first control resource set.

FIG. 4A and FIG. 4B are schematic diagrams of the two correspondences. As shown in FIG. 4A, the frequency-domain starting locations of the second control resource set and the first control resource set are identical, and as shown in FIG. 4B, the second offset value exists between the frequency-domain ending location of the second control resource set and the frequency-domain ending location of the first control resource set.

In some embodiments, the second configuration information of the second control resource set may be determined indirectly according to the first indication information. For example, when the first indication information is an index, an index obtained by performing offset by a third offset value on the index of the first control resource set is taken as an index of the second configuration information of the second control resource set. According to the index and the first table described above, the second configuration information of the second control set indicated by the index may be determined, and the second configuration information may include information of the same type as the first configuration information.

In some embodiments, a pattern multiplexed by a synchronization signal block to which the second control resource set corresponds and the second control resource set may also be determined according to the first indication information, the pattern multiplexed by the synchronization signal block to which the second control resource set corresponds and the second control resource set is identical to the pattern multiplexed by the synchronization signal block to which the first control resource set corresponds in the first configuration information and the first control resource set. For example, in FIG. 4A and FIG. 4B, the patterns multiplexed by the synchronization signal blocks and the second control resource set are both 1.

In some embodiments, the first offset value to which the second control resource set corresponds may also be determined according to the first indication information. For example, when the frequency-domain starting locations of the first control resource set and the second control resource set are identical, the first offset value to which the second control resource set corresponds is equal to the first offset value to which the first control resource set correspond; for example, when there is a second offset value between the frequency-domain starting locations of the first control resource set and the second control resource set, the first offset value to which the second control resource set corresponds is equal to a value obtained by performing offset by the second offset value on the first offset value to which the first control resource set corresponds.

In some embodiments, the time-domain length of the second control resource set may also be determined according to the first indication information, for example, the time-domain length of the second control resource set is less than or equal to a time-domain length indicated by the time-domain length information contained in the first configuration information; for example, the number of symbols of the second control resource set 0 is less than or equal to the number of symbols of the first control resource set 0, or the time-domain length of the second control resource set is equal to a time-domain length to which the index of the second control resource set corresponds. For example, the index of the second control resource set 0 is determined according to the first indication information, and the time-domain length (such as the number of symbols) of the second control resource set 0 is determined according to the index and the first table described above.

In some embodiments, the frequency-domain bandwidth of the second control resource set may also be determined according to the first indication information. For example, the frequency-domain bandwidth of the second control resource set is equal to a frequency-domain bandwidth to which the index of the second control resource set corresponds; for example, the index of the second control resource set 0 is determined according to the first indication information, and the frequency-domain bandwidth (such as the number of RBs) of the second control resource set 0 is determined according to the index and the first table described above. However, the embodiments of this disclosure is not limited thereto. For example, the frequency-domain bandwidth of the second control resource set may also be a predefined bandwidth, such as a maximum bandwidth supported by the terminal equipment, or a bandwidth of the SSB, or 50 MHz, or 100 MHz, etc.

In some embodiments, the terminal equipment monitors a PDCCH on a resource of the second control resource set, finds a PDSCH indicated by the PDCCH according to the monitored PDCCH, and receives the PDSCH, so as to obtain system information on the PDSCH. For example, the terminal equipment may monitor the PDCCH on the resource of the second control resource set 0, and finds the PDSCH corresponding to SIB1 according to the PDCCH, thereby obtaining SIB1. The monitoring may also be supervising, surveilling, watching, checking, detecting, and receiving (trying to receive or starting to receive), etc.

The above description is given by taking that the first control resource set and the second control resource set are control resource set 0 as an example. However, the embodiments of this disclosure is not limited thereto, and the first control resource set and the second control resource set may also be other control resource sets than the control resource set 0, such as other common control resource sets, etc., which may be used to receive other types of system information or paging or random access responses, etc., which shall not be enumerated herein any further. The first indication information is not limited to being included in the master information block, for example, it may also be included in system information type 1 (SIB1), etc.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

For example, in the embodiments, the terminal equipment determines related information of the second control resource set used thereby based on related information of the first control resource set indicated by the indication information, and monitors the PDCCH on the resource in the second control resource set, and receives the system information by the PDSCH scheduled by the PDCCH, instead of receiving the PDCCH on the bandwidth of the first control resource set, thereby enabling the terminal equipment with a smaller bandwidth capability to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Second Aspect

The embodiments of this disclosure provide a data reception method, which shall be described from a side of a terminal equipment. This method differs from the embodiments of the first aspect in that the terminal equipment determines second configuration information of a second control resource set according to a synchronization signal block (SSB) corresponding to the first control resource set.

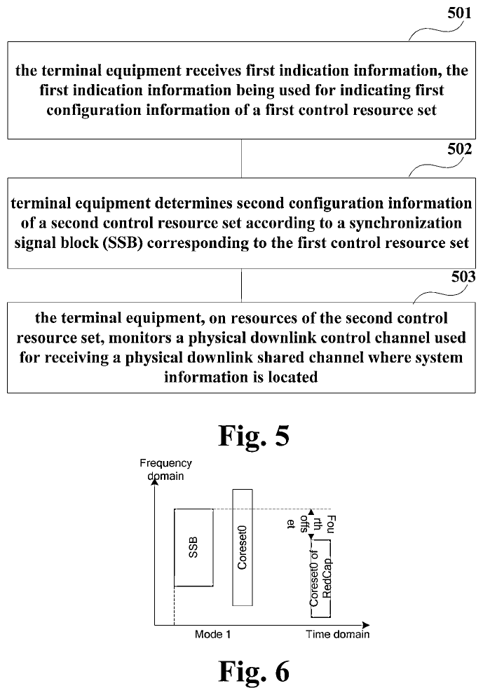

FIG. 5 is a schematic diagram of the data reception method of the embodiment of this disclosure. As shown in FIG. 5, the method includes:

501: the terminal equipment receives first indication information, the first indication information being used for indicating first configuration information of a first control resource set;

502: terminal equipment determines second configuration information of a second control resource set according to a synchronization signal block (SSB) corresponding to the first control resource set; and

503: the terminal equipment, on resources of the second control resource set, monitors a physical downlink control channel used for receiving a physical downlink shared channel where system information is located.

It should be noted that FIG. 5 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 5.

In some embodiments, reference may be made to 201 and 203 in the embodiments of the first aspect for the operations in 501 and 503, which shall not be repeated herein any further.

In some embodiments, during initial access, the terminal equipment may detect an SSB transmitted by a cell through cell search. A physical broadcast channel (PBCH) of the SSB carries a master information block (MIB), the MIB contains the first indication information indicating the first configuration information of the first control resource set, and an SSB to which the first control resource set corresponds refers to an SSB where an MIB carrying the first indication information indicating the first configuration information of the first control resource set is located.

In some embodiments, the terminal equipment determines that there is a correspondence between the frequency-domain location of the second control resource set and the frequency-domain location of the SSB, for example, the frequency-domain starting and/or ending and/or central location(s) of the SSB is/are taken as the frequency-domain starting and/or ending and/or central location(s) of the second control resource set; or, a location/locations obtained by performing offset by a fourth offset value on the frequency-domain starting and/or ending and/or central location(s) of the SSB is/are taken as the frequency-domain starting and/or ending and/or central location(s) of the second control resource set. The fourth offset value may be an offset value between RB indices, or an offset value between sub-channel indices, or an offset value between resource element (RE) indices.

For example, the frequency-domain starting or ending or central location may be represented by a resource block index, that is, a first RB index (starting location) of the SSB is taken as a minimum RB index (starting location) of the second control resource set; and/or, a last RB index (ending location) of the SSB is taken as a maximum RB index (ending location) of the second control resource set; and/or, a central RB index (central location) of the SSB is taken as the central RB index (central location) of the second control resource set.

For example, a location obtained by performing offset by the fourth offset value on the first RB index (the starting location) of the SSB is taken as the minimum RB index (the starting location) of the second control resource set; and/or, a location obtained by performing offset by the fourth offset value on the last RB index (the ending location) of the SSB is taken as the maximum RB index (the ending location) of the second control resource set; and/or, a location obtained by performing offset by the fourth offset value on the central RB index (the central location) of the SSB is taken as the central RB index (the central location) of the second control resource set. For another example, the frequency-domain starting or ending or central location may be represented by a sub-channel index, or a resource element (RE) index, etc., which is similar to representing by the resource block index, and shall not be described herein any further.

FIG. 6 is a schematic diagram of a correspondence of frequency-domain location between the SSB and a second control resource set. As shown in FIG. 6, there is a fourth offset value between the frequency-domain ending location of the second control resource set and the frequency-domain ending location of the SSB.

In some embodiments, reference may be made to the embodiments of the first aspect for the method for determining the time-domain length and/or frequency-domain bandwidth of the second control resource set, which shall not be repeated herein any further.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

For example, in the embodiments, the terminal equipment determines related information of the second control resource set used thereby based on related information of the SSB, and receives the PDCCH on the bandwidth in the second control resource set, and receives the system information by the PDSCH scheduled by the PDCCH, instead of receiving the PDCCH on the bandwidth of the first control resource set, thereby enabling the terminal equipment with a smaller bandwidth capability to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Third Aspect

In a 5G NR system, a search space (SS) corresponds to a CORESET. The search space contains such information as a time-domain location and period for monitoring a PDCCH, and a UE monitors a specific PDCCH/DCI in the search space.

The embodiments of this disclosure provide a data reception method, which shall be described from a side of a terminal equipment. This method differs from the embodiments of the first and second aspects in that how the terminal equipment determines a search space for monitoring a PDCCH is explained in this embodiment.

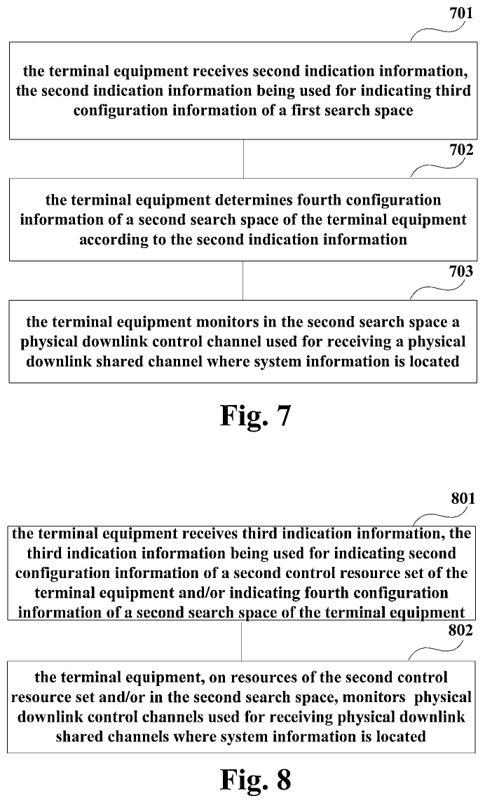

FIG. 7 is a schematic diagram of the data reception method of the embodiment of this disclosure. As shown in FIG. 7, the method includes:

701: the terminal equipment receives second indication information, the second indication information being used for indicating third configuration information of a first search space;

702: the terminal equipment determines fourth configuration information of a second search space of the terminal equipment according to the second indication information; and

703: the terminal equipment monitors in the second search space a physical downlink control channel used for receiving a physical downlink shared channel where system information is located.

It should be noted that FIG. 7 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 7.

In some embodiments, the first search space refers to a common search space of a PDCCH of type 0 (Type0-PDCCH CSS), also referred to as search space 0 (SS #0 or SS index 0 or SS ID 0), and the common search space of the PDCCH of type 0 is a PDCCH scheduling a PDSCH where system information is transmitted, that is, the PDCCH is used for scheduling the PDSCH, and the PDSCH carries the system information. For example, the system information may be system information type 1 (SIB1). In order to distinguish from a second search space 0 described later, the first search space 0 represents an existing search space 0 configured by a network device for the terminal equipment, such as a search space 0 used by a related terminal equipment in receiving a PDCCH of a PDSCH where the SIB is located. The related terminal equipment may be another terminal equipment than an RedCap UE or a terminal equipment with a related bandwidth capability (for example, the bandwidth capability is greater than or equal to 100 MHz).

In some embodiments, the search space 0 is associated with the control resource set 0, that is, the first search space is associated with the first control resource set in the embodiments of the first aspect, and the second search space is associated with the second control resource set in the embodiments of the first aspect.

In some embodiments, the second indication information is contained in a master information block (MIB) to indicate third configuration information of the first search space. For example, the network device may preconfigure a second table or predefine the second table. The second table includes a correspondence between the second indication information and the third configuration information of the first search space. The second indication information may be a row index of the second table. After receiving the second indication information, the terminal equipment may determine the third configuration information indicated by the second indication information by looking up the table. The third configuration information includes an initial OFDM symbol index, the number of search space sets in each slot, and at least one of O and M; where, O denotes a starting location of a PDCCH monitoring occasion corresponding to a first SSB, and M denotes an overlapping degree of the PDCCH monitoring occasions corresponding to an SSB index i and an SSB index i+1. The terminal equipment uses these parameters to calculate a slot where the PDCCH is monitored.

In some embodiments, the terminal equipment may be a terminal equipment with a small bandwidth capability (such as less than or equal to 50 MHz), such as an Redcap UE supporting a bandwidth of 50 MHz, and reference may be made to the embodiments of the first aspect for details.

In some embodiments, the terminal equipment determines fourth configuration information of the second search space of the terminal equipment according to the second indication information. The fourth configuration information may include information of the same type as the third configuration information, or may determine information representing a time-domain location of the second search space according to the third configuration information, such as an index of the second search space. The second search space is search space 0 (search space 0 or SS #0 or SS index 0 or SS ID 0), i.e. search space 0 used by the terminal equipment to monitor the PDCCH used for receiving the PDSCH where SIB1 is located. Hence, the terminal equipment does not monitor the PDCCH used for receiving the PDSCH where the system information is located in the first search space, so as to avoid a problem of unable to receive the PDCCH correctly, which shall be described below in detail.

In some embodiments, the terminal equipment determines that there is a correspondence between the second search space and the first search space indicated by the second indication information. For example, when the second indication information is an index, the index obtained by performing a fifth offset value plus on an index indicated by the second indication information is taken as the index of the second search space; or, the index of the second search space is determined according to the index of the first search space and a predetermined relationship between the first search space index the and the second search space index. For example, a third table representing a correspondence between the first search space index the and the second search space index is preconfigured or predefined, and the information indicated by the index may be determined with reference to the second table above, which shall not be repeated herein any further.

In some embodiments, the terminal equipment determines that the PDCCH monitoring occasion in the second search space does not overlap with the PDCCH monitoring occasion in the first search space. The terminal equipment may make the PDCCH monitoring occasion in the second search space not overlap with the PDCCH monitoring occasion in the first search space in the following methods, however, they are not limited thereto.

For example, the terminal equipment determines a first PDCCH monitoring occasion corresponding to the index indicated by the second indication information, and selects an index of a search space corresponding to a second PDCCH monitoring occasion not overlapping with the first PDCCH monitoring occasion (such as a minimum index, but it is not limited to the minimum index) as the index of the second search space. Taking four SSBs transmitted in a cell as an example, Table 1 below shows a correspondence between the second indication and parameters related to PDCCH monitoring occasions. As shown in Table 1, when the first indication is index 0, corresponding 0 is 0, the number of SS sets of each slot is 1, M is 1, and a first symbol index is 0. Therefore, corresponding first PDCCH monitoring occasions are calculated as slots 0,1,2,3, reference may be made to formula (1) below for a specific calculation formula, values of i are 0,1,2,3, corresponding to SSB indices 0 to 3, the second PDCCH monitoring occasion not overlapping with the first PDCCH monitoring occasion may be slots 5,6,7,8, and an index of a corresponding search space is 4, that is, the terminal equipment takes the third configuration information indicated by index 4 as the fourth configuration information of second search space 0.

TABLE 1

| | | | | | Calculated PDCCH | | | |
|---|---|---|---|---|---|---|---|---|
| | | The number | | | monitoring occasions | | | |
| Index | | of SS sets | | | (corresponding to SSB | | | |
| of SS0 | O | of each slot | M | First symbol index | indices 0-3) | | | |
| 0 | 0 | 1 | 1 | 0 | 0 | 1 | 2 | 3 |
| 1 | 0 | 2 | 0.5 | 0 when i is an even | 0 | 0 | 1 | 1 |
| | | | | number, | | | | |
| | | | | the number of | | | | |
| | | | | symbols of a coreset | | | | |
| | | | | when i is an odd | | | | |
| | | | | number | | | | |
| 2 | 2 | 1 | 1 | 0 | 2 | 3 | 4 | 5 |
| 3 | 2 | 2 | 0.5 | 0 when i is an even | 2 | 2 | 3 | 3 |
| | | | | number, | | | | |
| | | | | the number of | | | | |
| | | | | symbols of a coreset | | | | |
| | | | | when i is an odd | | | | |
| | | | | number | | | | |
| 4 | 5 | 1 | 1 | 0 | 5 | 6 | 7 | 8 |
| 5 | 5 | 2 | 0.5 | 0 when i is an even | 5 | 5 | 6 | 6 |
| | | | | number, | | | | |
| | | | | the number of | | | | |
| | | | | symbols of a coreset | | | | |
| | | | | when i is an odd | | | | |
| | | | | number | | | | |
| 6 | 7 | 1 | 1 | 0 | 7 | 8 | 9 | 0 |
| 7 | 7 | 2 | 0.5 | 0 when i is an even | 7 | 7 | 8 | 8 |
| | | | | number, | | | | |
| | | | | the number of | | | | |
| | | | | symbols of a coreset | | | | |
| | | | | when i is an odd | | | | |
| | | | | number | | | | |
| 8 | 0 | 1 | 2 | 0 | 0 | 2 | 4 | 6 |
| 9 | 5 | 1 | 2 | 0 | 5 | 7 | 9 | 1 |
| 10 | 0 | 1 | 1 | 1 | 0 | 1 | 2 | 3 |
| 11 | 0 | 1 | 1 | 2 | 0 | 1 | 2 | 3 |
| 12 | 2 | 1 | 1 | 1 | 2 | 3 | 4 | 5 |
| 13 | 2 | 1 | 1 | 2 | 2 | 3 | 4 | 5 |
| 14 | 5 | 1 | 1 | 1 | 5 | 6 | 7 | 8 |
| 15 | 5 | 1 | 1 | 2 | 5 | 6 | 7 | 8 |

Or, for example, the terminal equipment takes the index indicated by the second indication information as the index of the second search space, calculates a starting slot index for monitoring the PDCCH in the second search space according to the third configuration information corresponding to the index indicated by the second indication information, and takes an index obtained by performing offset by a sixth offset value on the starting slot index as a starting slot index for monitoring the PDCCH in the second search space; that is, the terminal equipment uses configuration information corresponding to the same index as a related terminal equipment. For example, 0, M, the first symbol index and the number of SS sets in each slot of the second search element space are all identical to those in the first search space. However, when calculating the initial slot index for monitoring the PDCCH in the search space according to the above information, calculation methods of the first search space and the second search space are different, so that the starting slots for monitoring the PDCCH or the PDCCH monitoring occasions of the first search space and the second search space are not overlapped (staggered). For example, when the starting slot index for monitoring the PDCCH of the first search space is calculated, the third configuration information is inputted into formula (1)—(O·2^{μ}+┌i·M┘)mod/Nₛₗₒₜ^{frame,μ}, and when the starting slot index for monitoring the PDCCH of the second search space is calculated, the third configuration information is inputted into a formula (O·2^{μ}+┌i·M┘)mod/Nₛₗₒₜ^{frame,μ}+k; where, k is a sixth offset value, for example, k=2, Nₛₗₒₜ^{frame,μ} denotes the number of SS sets of each slot, a value range of μ is 0,1,2,3 according to a subcarrier spacing, and i denotes an SSB index.

Or, for example, the index indicated by the second indication information is taken as the index of the second search space, and a first system frame number of a radio frame where a slot for monitoring the PDCCH is located in the second search space is calculated according to the third configuration information corresponding to the index indicated by the second indication information, the first system frame number being not overlapped with a second system frame number of a radio frame where a slot for monitoring the PDCCH is located in the first search space; that is, the terminal equipment uses configuration information corresponding to the same index as a related terminal equipment. For example, O, M, the first symbol index and the number of SS sets in each slot of the second search element space are all identical to those in the first search space. However, when calculating the system frame number of the radio frame where the slot for monitoring the PDCCH is located in the search space according to the above information, calculation methods of the first search space and the second search space are different, so that the second system frame number and the first system frame number are not overlapped. For example, the third configuration information is inputted into formula (2)—┐(O·2^{μ}+┐i·M┘/Nₛₗₒₜ^{frame,μ}┘ mod 2; where, Nₛₗₒₜ^{frame,μ} denotes the number of SS sets of each slot, a value range of μ is 0,1,2,3 according to a subcarrier spacing. In calculating the first system frame number, when a result of the formula is 0, the first system frame number is of an even frame, and when a result of the formula is 1, the first system frame number is of an odd frame; and when calculating the second system frame number, when a result of the formula is 0, the second system frame number is of an odd frame, and when a result of the formula is 1, the second system frame number is of an even frame. For example, the second system frame number may be calculated by using a formula ┐(O·2^{μ}+┌i·M┘/Nₛₗₒₜ^{frame,μ})┘ mod 2+1 or ┐(O·2^{μ}+┌i·M┘/Nₛₗₒₜ^{frame,μ})┘ mod 2−1. Hence, the second system frame number is not overlapped with the first system frame number. In some embodiments, the terminal equipment monitors the PDCCH in the second search space, finds out the PDSCH indicated by the monitored PDCCH, and receives the PDSCH, so as to acquire system information on the PDSCH, such as SIB1.

The above description is given by taking that the first control resource set and the second control resource set are control resource set 0 as an example. However, the embodiments of this disclosure is not limited thereto, and the first control resource set and the second control resource set may also be other control resource sets than the control resource set 0, such as other common control resource sets, etc., which may be used to receive other types of system information or paging or random access responses, etc., which shall not be enumerated herein any further. The second indication information is not limited to being included in the master information block, for example, it may also be included in system information type 1 (SIB1), etc.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiment that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

For example, in the embodiments, the terminal equipment determines related information of the second control resource set used thereby based on related information of the first control resource set indicated by the indication information, and monitors the PDCCH in the second search space, and receives the system information by the PDSCH scheduled by the PDCCH, instead of monitoring the PDCCH in the first search space, thereby enabling the terminal equipment with a smaller bandwidth capability to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Fourth Aspect

The embodiments of this disclosure provide a data reception method, which shall be described from a side of a terminal equipment. The terminal equipment may be a terminal equipment with a smaller bandwidth capability (such as less than or equal to 50 MHz), such as an RedCap UE supporting a bandwidth of 50 MHz, and reference may be made to the embodiments of the first aspect for details. This method differs from the embodiments of the first to the third aspects in that a network device directly configures the terminal equipment (such as an RedCap UE) with configuration information of its second control resource set and/or second search space.

FIG. 8 is a schematic diagram of the data reception method of the embodiment of this disclosure. As shown in FIG. 8, the method includes:

801: the terminal equipment receives third indication information, the third indication information being used for indicating second configuration information of a second control resource set of the terminal equipment and/or indicating fourth configuration information of a second search space of the terminal equipment; and

802: the terminal equipment, on resources of the second control resource set and/or in the second search space, monitors physical downlink control channels used for receiving physical downlink shared channels where system information is located.

It should be noted that FIG. 8 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 8.

In some embodiments, reference may be made to the embodiments of the previous three aspects for meanings of the second control resource set and the second search space, reference may be made to the first configuration information of the first aspect for the information in the second configuration information, and reference may be made to the third configuration information of the third aspect for the information in the fourth configuration information, which shall not be repeated herein any further.

In some embodiments, the third indication information is contained in a master information block (MIB), and may be indication information of 1 bit, such as 1 (space) bit in a current MIB, which is used to indicate the second configuration information of the second control resource set of the terminal equipment and/or the fourth configuration information of the second search space. The terminal equipment determines the second configuration information of the second control resource set and/or the fourth configuration information indicating the second search space of the terminal equipment according to a third indication information and a correspondence between the third indication information and the second configuration information of the second control resource set and/or the fourth configuration information indicating the second search space of the terminal equipment.

For example, the network device may preconfigure the fourth table or predefine a fourth table. The fourth table includes a correspondence between the third indication information and the row index (or the configured index) in the first table or the third table in the first or third embodiments. Table 2 below is a schematic diagram of the fourth table. As shown in Table 2, when a bit value is 0, it indicated that the index of the second control resource set is M1, and when the bit value is 1, it indicates that the index of the second control resource set is N1; or, when the bit value is 0, it indicates that the index of the second search space is M2, and when the bit value is 1, it indicates that the index of the second search space is N2; or, when the bit value is 0, it indicates that the index of the second control resource set is M3, and when the bit value is 1, it indicates that the index of the second search space is N3; or, when the bit value is 0, it indicates that the index of the second search space is M4, and when the bit value is 1, it indicates that the index of the second control resource set is N4; where, M1, M2, M3, M4, N1, N2, N3 and N4 are integers from 0 to 15, N1 is not equal to M1, and N2 is not equal to M2. According to the index of the second control resource set and the fourth table, the second configuration information of the second control resource set corresponding to the index is determined, and/or, according to the index of the second search space and the fourth table, the fourth configuration information of the second search space corresponding to the index is determined.

TABLE 2

| Third | | | | |
|---|---|---|---|---|
| indication | | | | |
| information | Example 1 | Example 2 | Example 3 | Example 4 |
| 0 | Index M1 of | Index M2 of | Index M3 | Index M4 of |
| | the second | the second | of the second | the second |
| | control | search space | control | search space |
| | resource set | | resource set | |
| 1 | Index N1 of | Index N2 of | Index N3 of | Index N4 of |
| | the second | the second | the second | the second |
| | control | search space | search space | control |
| | resource set | | | resource set |

In some embodiments, the absolute location(s) of a time-domain and/or frequency-domain of the PDCCH may be determined according to the second configuration information and/or the fourth configuration information. For example, the frequency-domain absolute location of PDCCH may be determined according to the second configuration information, and the time-domain absolute location of the PDCCH may be determined according to the second configuration information in combination with the fourth configuration information, the PDCCH is monitored at a corresponding location, the PDSCH indicated by the PDCCH is found according to the monitored PDCCH, and the PDSCH is received, so as to obtain the system information on the PDSCH.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiment that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

For example, in the embodiments, the terminal equipment determines its search space and/or control resource set according to the indication information newly configured by the network device for this type of terminal equipment, instead of determining a search space and/or control resource set by using existing indication information, thereby enabling the terminal equipment with a smaller bandwidth capability to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Fifth Aspect

The embodiments of this disclosure provide a data reception method, which shall be described from a side of a terminal equipment. The terminal equipment may be a terminal equipment with a smaller bandwidth capability (such as less than or equal to 50 MHz), such as an RedCap UE supporting a bandwidth of 50 MHz, and reference may be made to the embodiments of the first aspect for details.

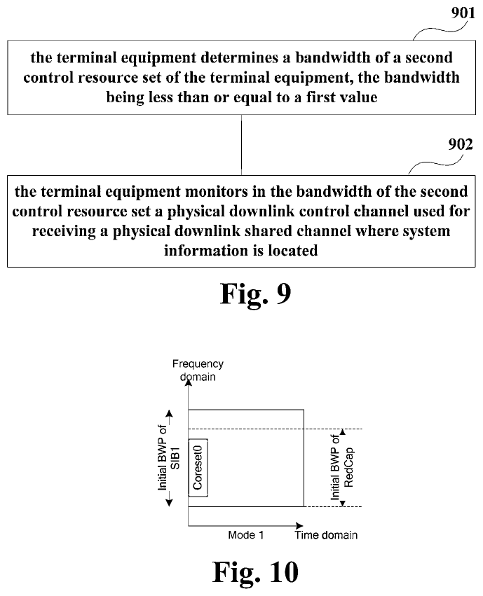

FIG. 9 is a schematic diagram of the data reception method of the embodiment of this disclosure. As shown in FIG. 9, the method includes:

901: the terminal equipment determines a bandwidth of a second control resource set of the terminal equipment, the bandwidth being less than or equal to a first value; and

902: the terminal equipment monitors in the bandwidth of the second control resource set a physical downlink control channel used for receiving a physical downlink shared channel where system information is located.

It should be noted that FIG. 9 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 9.

In some embodiments, the second control resource set is control resource set 0, and the system information may be system information type 1 (SIB1). Reference may be made to the embodiments of the first aspect for details, which shall not be repeated herein any further.

In some embodiments, the first value is related to a maximum bandwidth capability of the terminal equipment, and the terminal equipment does not expect that the bandwidth of the second control resource set is greater than the maximum bandwidth capability of the terminal equipment. For example, the maximum bandwidth capability of the terminal equipment is 50 MHz, and the terminal equipment determines that the bandwidth of the second control resource set of the terminal equipment is less than or equal to 50 MHz, in other words, the terminal equipment does not expect the bandwidth of the second control resource set is greater than 50 MHz, and the terminal equipment will not receive a PDCCH in a bandwidth greater than 50 MHz.

In some embodiments, a frequency-domain location of the physical downlink data channel (such as a PDSCH carrying SIB1) indicated by the physical downlink control channel is within the bandwidth of the second control resource set. For example, the location and bandwidth of the PDSCH are identical to those of the second control resource set, or the bandwidth of the PDSCH is within the bandwidth of the second control resource set, for example, a starting and ending locations of the bandwidth of PDSCH are within the bandwidth of the second control resource set, such as within the bandwidth of the second control resource set 0, thereby ensuring that the terminal equipment correctly receives the PDSCH.

In some embodiments, the second control resource set is configured by a network device, such as being configured in a master information block (MIB). The second control resource set is corresponds to the first control resource set in the embodiments of the first aspect. Reference may be made to the embodiments of the first aspect for a specific configuration mode, which shall not be repeated herein any further.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

For example, in the embodiments, the network device will not transmit the PDCCH in a relatively large bandwidth, hence, the terminal equipment will not receive the PDCCH in a relatively large bandwidth, so that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

The above embodiments of the first to fifth aspects solve a problem that the terminal equipment may possibly fail in receiving a PDCCH if the bandwidth capability of the terminal equipment is lower than the bandwidth of the control resource set.

Currently, initial downlink bandwidth part (initial DL BWP) may be used for a terminal equipment to receive a downlink channel and/or signal, such as control information and/or data and/or a reference signal, and a network device may configure related information of an initial downlink bandwidth part (such as locationAndBandwidth, etc.) for the terminal equipment in system information type 1 (SIB1). FIG. 10 is a schematic diagram of the BWP configuration. As shown in FIG. 10, the network device configures the initial downlink bandwidth part, and after receiving the related information of the initial downlink bandwidth part, the terminal equipment may determine the location and bandwidth of the initial downlink bandwidth part; however, the terminal equipment will keep the control resource set 0, until it receives radio resource control (RRC) related information.

It was found by the inventors that the terminal equipment will use the initial downlink bandwidth part to receive downlink control information and/or data upon receiving the radio resource control related message; however, if the bandwidth capability of the terminal equipment is lower than a bandwidth of the initial bandwidth part, the terminal equipment may possibly fail in receiving the downlink channel and/or signal, thereby resulting in drop of data. How to solve the above technical problems shall be described below with reference to embodiments of a sixth to eighth aspects.

### Embodiments of the Sixth Aspect

The embodiments of this disclosure provides a data reception method, which shall be described from a side of a terminal equipment.

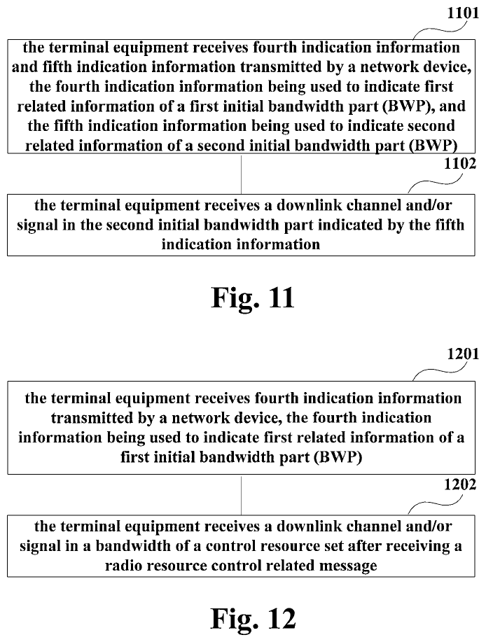

FIG. 11 is a schematic diagram of the data reception method of the embodiment of this disclosure. As shown in FIG. 11, the method includes:

1101: the terminal equipment receives fourth indication information and fifth indication information transmitted by a network device, the fourth indication information being used to indicate first related information of a first initial bandwidth part (BWP), and the fifth indication information being used to indicate second related information of a second initial bandwidth part (BWP); and

1102: the terminal equipment receives a downlink channel and/or signal in the second initial bandwidth part indicated by the fifth indication information.

It should be noted that FIG. 11 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 11.

In some embodiments, the fourth indication information is included in system information and used to indicate a location and bandwidth of the first initial BWP. For example, the system information may be system information type 1 (SIB1). To distinguish from the second related information of the second initial bandwidth part described later, the first related information may be an existing location and bandwidth (locationAndBandwidth) of an initial BWP configured by a network device for the terminal equipment, and the first related information may further include at least one of a subcarrier spacing, a cyclic prefix, PDCCH configuration and PDSCH configuration. For example, a related terminal equipment determines the first initial BWP according to the first related information after receiving SIB1, and after receiving a radio resource control message, receives the downlink channel and/or signal on the first initial BWP. The related terminal equipment may be another terminal equipment than an RedCap UE or a terminal equipment with a related bandwidth capability (such as a bandwidth capability greater than or equal to 100 MHz).

In some embodiments, the fifth indication information is also included in the system information (such as SIB1), and is used to indicate second related information of a second initial bandwidth part (BWP) of a reduced capability terminal equipment, the second related information including an offset and/or a location and/or a bandwidth; wherein the offset denotes an offset between a starting or ending or central location of the second initial bandwidth part and a starting or ending or central location of the first initial bandwidth part. For example, the starting or ending or central location may be represented by a resource block index, that is, a location obtained by performing offset by a seventh offset value on a minimum RB index (starting location) of the first initial bandwidth part is taken as a minimum RB index (starting location) of the second initial bandwidth part; or, a location obtained by performing offset by a seventh offset value on a maximum RB index (ending location) of the first initial bandwidth part is taken as a maximum RB index (ending location) of the second initial bandwidth part; or, a location obtained by performing offset by a seventh offset value on a central RB index (central location) of the first initial bandwidth part is taken as a central RB index (central location) of the second initial bandwidth part. When the second related information include a bandwidth and/or location, the terminal equipment takes the bandwidth as the bandwidth of its second initial BWP, and determines the location of the second initial BWP according to the location. For another example, the starting or ending or central location may be represented by a sub-channel index or a resource element index, which is similar to representing by a resource block index, and shall not be repeated herein any further. The seventh offset value may be an offset value between RB indices, or an offset value between sub-channel indices, or an offset value between RE (resource element) indices, etc.

Therefore, the reduced capability terminal equipment determines the second initial BWP according to the second related information after receiving the system information, and receives the downlink channel and/or signal in the second initial BWP after receiving the radio resource control related message, such as a PDCCH and/or a PDSCH and/or a reference signal, etc.

In some embodiments, the fifth indication information is included in the radio resource control related message. The radio resource control related message may be such messages as RRCSetup and/or RRCResume and/or RRCReestablishment, etc. In this implementation, the network device may first configure the first related information of the first initial bandwidth part (BWP) in SIB1, and the terminal equipment determines the first initial bandwidth part upon receiving the first related information; however, the terminal equipment continues to keep the control resource set 0, until it receives the radio resource control (RRC) related message. The network device adds the fifth indication information to the RRC-related message to indicate the second related information of the second initial BWP. For example, the second related information may be a location and bandwidth (locationAndBandwidth-rrc) of the second initial BWP. The second related information may further include at least one of a subcarrier spacing, a cyclic prefix, PDCCH configuration and PDSCH configuration, and the subcarrier spacing, cyclic prefix, PDCCH configuration and PDSCH configuration in the second related information may be identical to or different from the subcarrier spacing, cyclic prefix, PDCCH configuration and PDSCH configuration in the first related information. Therefore, the terminal equipment determines the second initial BWP according to the second related information after receiving the radio resource control related message, and the terminal equipment receives the downlink channel and/or signal in the second initial BWP. For example, the terminal equipment may be a terminal equipment with a small bandwidth capability, such as an RedCap UE supporting 50 MHz bandwidth, or may be an RedCap UE supporting a larger bandwidth (such as 100 MHz), or may be a non-RedCap UE. The act of receiving indicates an attempt to receive or starting to receive or having received a downlink channel and/or signal; however, the embodiments of this disclosure is not limited thereto.

In some embodiments, the second initial bandwidth part covers the control resource set of the terminal equipment. For example, the bandwidth of the second initial bandwidth part includes the bandwidth of the control resource set, the control resource set is the control resource set 0, such as the second control resource set in the previous embodiments, and reference may be made to the previous embodiments for a meaning of the control resource set 0, which shall not be repeated herein any further.

In some embodiments, the fifth indication information may further include information of the initial uplink BWP, such as information of the location and bandwidth of the initial uplink BWP, and the terminal equipment transmits an uplink channel and/or uplink signal in the initial uplink BWP, such as a PUCCH or a PUSCH or an SRS.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

For example, in the embodiments, with the newly-configured related information of the second initial bandwidth part, the terminal equipment with a smaller bandwidth capability is enabled to correctly receive the downlink control channel and/or data channel in the second initial bandwidth part, such as a PDCCH and/or a PDSCH scheduled by the PDCCH, which is conducive to performing communications by a UE with a smaller bandwidth capability.

### Embodiments of the Seventh Aspect

The embodiments of this disclosure provides a data reception method, which shall be described from a side of a terminal equipment. The terminal equipment may be a terminal equipment with a smaller bandwidth capability, such as an RedCap UE supporting a bandwidth of 50 MHz, which shall not be described herein any further.

FIG. 12 is a schematic diagram of the data reception method of the embodiment of this disclosure. As shown in FIG. 12, the method includes:

1201: the terminal equipment receives fourth indication information transmitted by a network device, the fourth indication information being used to indicate first related information of a first initial bandwidth part (BWP); and

1202: the terminal equipment receives a downlink channel and/or signal in a bandwidth of a control resource set after receiving a radio resource control related message.

In some embodiments, reference may be made to the embodiments of the sixth aspect for the fourth indication information, the first initial bandwidth part and the first related information, which shall not be repeated herein any further.

In some embodiments, the network device may first configure the first related information of the first initial bandwidth part (initial BWP) in SIB1, and the terminal equipment determines the first initial bandwidth part upon receiving the first related information, and continues to maintain the control resource set, until it receives the radio resource control (RRC) related message, and continues to maintain the control resource set after receiving the radio resource control (RRC) related message, and the network device schedules the terminal equipment in the bandwidth of the control resource set, hence, the terminal equipment receives the downlink channel and/or signal in the bandwidth of the control resource set. The control resource set may be the control resource set 0. Reference may be made to the second control resource set in the previous embodiments for a specific implementation, which shall not be repeated herein any further.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

For example, in the embodiments, the downlink channel and/or signal, etc., is/are received in the bandwidth of the control resource set after the radio resource control related message is received, instead of receiving the downlink channel and/or signal, etc., in the initial bandwidth part, thereby enabling the terminal equipment with a smaller bandwidth capability to correctly receive the downlink channel and/or signal, etc., which is conducive to performing communications by a UE with a smaller bandwidth capability.

### Embodiments of an Eighth Aspect

The embodiments of this disclosure provide a data reception method, which shall be described from a side of a terminal equipment. This method differs from the embodiments of the sixth aspect in that the fifth indication information is not needed to be added in this embodiment, and second related information of the second initial bandwidth part may be determined according to the fourth indication information.

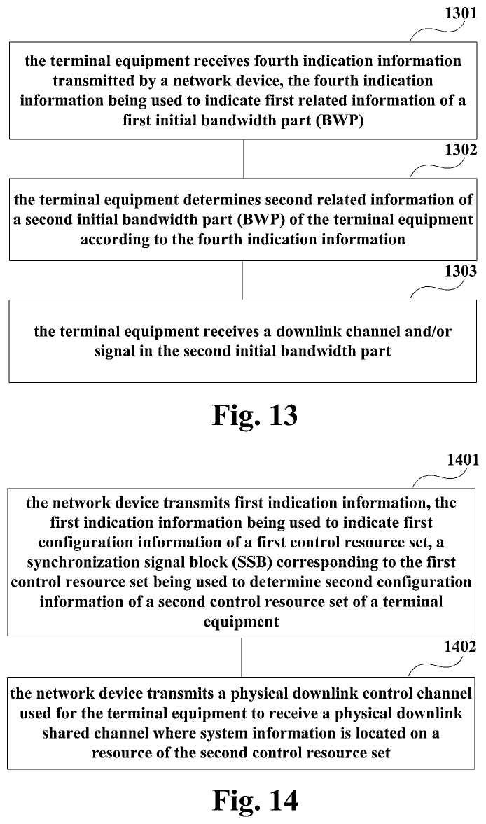

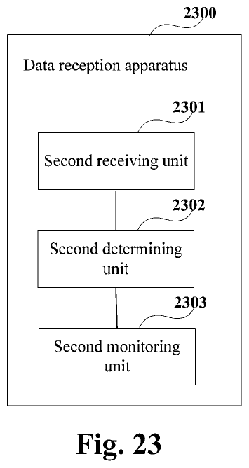

FIG. 13 is a schematic diagram of the data reception method of the embodiment of this disclosure. As shown in FIG. 23, the method includes:

1301: the terminal equipment receives fourth indication information transmitted by a network device, the fourth indication information being used to indicate first related information of a first initial bandwidth part (BWP);

1302: the terminal equipment determines second related information of a second initial bandwidth part (BWP) of the terminal equipment according to the fourth indication information; and

1303: the terminal equipment receives a downlink channel and/or signal in the second initial bandwidth part.

In some embodiments, reference may be made to the embodiments of the sixth aspect for implementations of operations 1301 and 1303, which shall not be repeated herein any further.

In some embodiments, the terminal equipment determines the second related information of the second initial bandwidth part (BWP) of the terminal equipment according to the fourth indication information, such as performing offset on a frequency-domain starting or ending or central location of the first initial bandwidth part by an eighth offset value, and taking the location after performing offset as a frequency-domain starting or ending or central location of the second initial bandwidth part. The eighth offset value may be an offset value between RB indices, or an offset value between sub-channel indices, or an offset value between RE (resource element) indices.

For example, the frequency-domain starting or ending or central location may be represented by a resource block index, that is, a minimum RB index (starting location) of the first initial bandwidth part is taken as a minimum RB index (starting location) of the second initial bandwidth part; or, a maximum RB index (ending location) of the first initial bandwidth part is taken as a maximum RB index (ending location) of the second initial bandwidth part; or, a central RB index (central location) of the first initial bandwidth part is taken as a central RB index (central location) of the second initial bandwidth part; or, a location obtained by performing offset on a minimum RB index (starting location) of the first initial bandwidth part by an eighth offset value is taken as a minimum RB index (starting location) of the second initial bandwidth part; or, a location obtained by performing offset on a maximum RB index (ending location) of the first initial bandwidth part by the eighth offset value is taken as a maximum RB index (ending location) of the second initial bandwidth part; or, a location obtained by performing offset on a central RB index (central location) of the first initial bandwidth part by the eighth offset value is taken as a central RB index (central location) of the second initial bandwidth part. For another example, the frequency-domain starting or ending or central location may also be represented by a sub-channel index or a resource element (RE) index, etc., which is similar to representing by the resource block index, and shall not be described herein any further.

In some embodiments, the terminal equipment determines the second related information of the second initial bandwidth part (initial BWP) of the terminal equipment according to the fourth indication information, such as taking a subcarrier spacing, a cyclic prefix, PDCCH configuration and PDSCH configuration in the first related information indicated by the fourth indication information as a subcarrier spacing, a cyclic prefix, PDCCH configuration and PDSCH configuration in the second related information.

In some embodiments, the bandwidth of the second initial bandwidth part may be a predefined bandwidth, such as a bandwidth that may be supported by the terminal equipment or a bandwidth of the 50 MHz or a bandwidth of an SSB or a bandwidth of a control resource set, which is not limited in this disclosure. The control resource set may be a control resource set 0, such as the second control resource set in the previous embodiments, and the SSB is an SSB corresponding to the control resource zero, and reference may be made to the embodiments of the second aspect for details.

In some embodiments, the second initial bandwidth part covers the control resource set of the terminal equipment, and the control resource set is a control resource set 0, such as the second control resource set in the previous embodiments. Reference may be made to the previous embodiments for a meaning of the control resource set 0, which shall not be described herein any further.

In some embodiments, the terminal equipment may be a terminal equipment with a small bandwidth capability, such as an RedCap UE supporting a bandwidth of 50 MHz, and this disclosure is not limited thereto.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

For example, in the embodiments, the terminal equipment determines the related information of the second initial bandwidth part used thereby according to the related information of the first initial bandwidth part indicated by the indication information, and receives the downlink channel and/or signal in the second initial bandwidth part, instead of receiving the downlink channel and/or signal in the first initial bandwidth part, thereby enabling the terminal equipment with a smaller bandwidth capability to correctly receive the PDCCH and/or the PDSCH scheduled by the PDCCH in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

In the above embodiments, the first to the eighth offset values may be predefined, and the embodiments of this disclosure are not limited thereto.

### Embodiments of a Ninth Aspect

The embodiments of this disclosure provide a data transmission method, which shall be described from a side of a network device. This method corresponds to the method in the embodiments of the first aspect, and parts repeated with the embodiments of the first aspect shall not be described herein any further.

FIG. 21 is a schematic diagram of the data transmission method of the embodiment of this disclosure. As shown in FIG. 21, the method includes:

2101: the network device transmits first indication information, the first indication information being used to indicate first configuration information of a first control resource set, and the first indication information being used to determine second configuration information of a second control resource set of a terminal equipment; and

2102: the network device transmits, on a resource of the second control resource set, a physical downlink control channel used for the terminal equipment to receive a physical downlink shared channel where system information is located.

In some embodiments, implementations of 2101-2102 correspond to those of 201 and 203 in the embodiments of the first aspect, and reference may be made to the embodiments of the first aspect for details, which shall not be described herein any further.

In some embodiments, reference may be made to the embodiments of the first aspect for implementations of the first indication information, the first control resource set, the first configuration information, the second control resource set and the second configuration information, which shall not be described herein any further.

In some embodiments, the network device also determines the second configuration information of the second control resource set of the terminal equipment according to the first indication information, and transmits the physical downlink control channel used for the terminal equipment to receive a physical downlink shared channel where system information is located on the resource of the second control resource set. Reference may be made to the embodiments of the first aspect for a mode for determining the second configuration information, which shall not be described herein any further.

In some embodiments, the network device transmits a PDCCH to a reduced capability terminal equipment (RedCap UE) at a first time, and transmits a PDCCH to a non-reduced capability terminal equipment (such as a related UE) at a second time, the first time and the second time being not overlapped. When the network device transmits the PDCCH, the related UE and the RedCap UE are temporally staggered, so as to avoid erroneous reception of the PDCCH by the related UE or the RedCap UE.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

For example, in the embodiments, the terminal equipment determines related information of the second control resource set used thereby based on related information of the first control resource set indicated by the indication information, receives the PDCCH in the second control resource set, and schedules the PDSCH by the PDCCH, so as to receive the system information, instead of receiving the PDCCH on the bandwidth of the first control resource set, thereby enabling the terminal equipment with a smaller bandwidth capability to correctly receive the downlink control channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Tenth Aspect

The embodiments of this disclosure provide a data transmission method, which shall be described from a side of a network device, with parts repeated with the embodiments of the second aspect being not going to be described herein any further.

FIG. 14 is a schematic diagram of the data transmission method of the embodiment of this disclosure. As shown in FIG. 14, the method includes:

1401: the network device transmits first indication information, the first indication information being used to indicate first configuration information of a first control resource set, a synchronization signal block (SSB) corresponding to the first control resource set being used to determine second configuration information of a second control resource set of a terminal equipment; and

1402: the network device transmits a physical downlink control channel used for the terminal equipment to receive a physical downlink shared channel where system information is located on a resource of the second control resource set.

In some embodiments, implementations of 1401-1402 corresponds to 501 and 503 in the embodiments of the second aspect, and reference may be made to the embodiments of the second aspect for details, which shall not be described herein any further.

In some embodiments, reference may be made to the embodiments of the second aspect for implementations of the first indication information, the first control resource set, the first configuration information, the second control resource set and the second configuration information, which shall not be described herein any further.

In some embodiments, the network device also determines the second configuration information of the second control resource set of the terminal equipment according to the synchronization signal block (SSB) to which the first control resource set corresponds, and transmits the physical downlink control channel used for the terminal equipment to receive a physical downlink shared channel where system information is located on the resource of the second control resource set. Reference may be made to the embodiments of the second aspect for a manner for determining the second configuration information, which shall not be described herein any further.

In some embodiments, the network device transmits a PDCCH to a reduced capability terminal equipment (RedCap UE) at a first time, and transmits a PDCCH to a non-reduced capability terminal equipment (such as a related UE) at a second time, the first time and the second time being not overlapped. When the network device transmits the PDCCH, the related UE and the RedCap UE are temporally staggered, so as to avoid erroneous reception of the PDCCH by the related UE or the RedCap UE.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

For example, in the embodiments, the terminal equipment determines related information of the second control resource set used thereby based on related information of the SSB, receives the PDCCH on the bandwidth in the second control resource set, and schedules the PDSCH by the PDCCH, so as to receive the system information, instead of receiving the PDCCH on the bandwidth of the first control resource set, thereby enabling the terminal equipment with a smaller bandwidth capability to correctly receive the downlink control channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of an Eleventh Aspect

The embodiments of this disclosure provide a data transmission method, which shall be described from a side of a network device, with parts repeated with the embodiments of the third aspect being not going to be described herein any further.

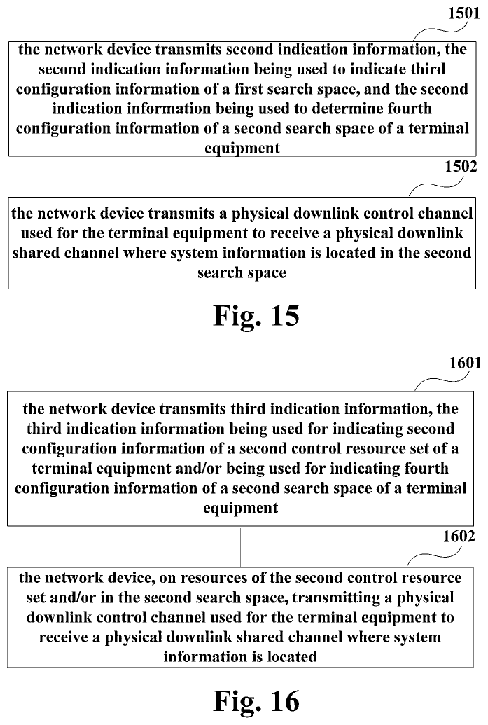

FIG. 15 is a schematic diagram of the data transmission method of the embodiment of this disclosure. As shown in FIG. 15, the method includes:

1501: the network device transmits second indication information, the second indication information being used to indicate third configuration information of a first search space, and the second indication information being used to determine fourth configuration information of a second search space of a terminal equipment; and

1502: the network device transmits a physical downlink control channel used for the terminal equipment to receive a physical downlink shared channel where system information is located in the second search space.

In some embodiments, implementations of 1501-1502 corresponds to 701 and 703 in the embodiments of the third aspect, and reference may be made to the embodiments of the third aspect for details.

In some embodiments, reference may be made to the embodiments of the third aspect for implementations of the second indication information, the first search space, the third configuration information, the second search space and the fourth configuration information, which shall not be described herein any further.

In some embodiments, the network device also determines the fourth configuration information of the second search space of the terminal equipment according to the second indication information, and transmits the physical downlink control channel used for the terminal equipment to receive a physical downlink shared channel where system information is located in the second search space. Reference may be made to the embodiments of the third aspect for a mode for determining the fourth configuration information, which shall not be described herein any further.

In some embodiments, the network device transmits a PDCCH to a reduced capability terminal equipment (RedCap UE) at a first time, and transmits a PDCCH to a non-reduced capability terminal equipment (such as a related UE) at a second time, the first time and the second time being not overlapped. When the network device transmits the PDCCH, the related UE and the RedCap UE are temporally staggered, so as to avoid erroneous reception of the PDCCH by the related UE or the RedCap UE.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

For example, in this embodiment, the terminal equipment determines related information of the second search space used thereby based on related information of the first search space indicated by the indication information, monitors the PDCCH in the second search space, and schedules the PDSCH by the PDCCH, so as to receive the system information, instead of monitoring the PDCCH in the first search space, thereby enabling the terminal equipment with a smaller bandwidth capability to correctly receive the downlink control channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Twelfth Aspect

The embodiments of this disclosure provide a data transmission method, which shall be described from a side of a network device, with parts repeated with the embodiments of the fourth aspect being not going to be described herein any further.

FIG. 16 is a schematic diagram of the data transmission method of the embodiments of this disclosure. As shown in FIG. 16, the method includes:

1601: the network device transmits third indication information, the third indication information being used for indicating second configuration information of a second control resource set of a terminal equipment and/or being used for indicating fourth configuration information of a second search space of a terminal equipment; and

1602: the network device, on resources of the second control resource set and/or in the second search space, transmits a physical downlink control channel used for the terminal equipment to receive a physical downlink shared channel where system information is located.

In some embodiments, reference may be made to the embodiments of the first three aspects for meaning of the second control resource set and the second search space, reference may be made to the first configuration information of the first aspect for the information in the second configuration information, and reference may be made to the third configuration information of the third aspect for the information in the fourth configuration information, which shall not be repeated herein any further.

In some embodiments, reference may be made to the embodiments of the fourth aspect for implementation of the third indication information, and implementations of 1601-1602 corresponds to 801-802 in the embodiments of the fourth aspect, which shall not be repeated herein any further.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

For example, in the embodiments, the terminal equipment determines its search space and/or control resource set according to the indication information newly configured by the network device for this type of terminal equipment, instead of determining a search space and/or control resource set by using existing indication information, thereby enabling the terminal equipment with a smaller bandwidth capability to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Thirteenth Aspect

The embodiments of this disclosure provide a data transmission method, which shall be described from a side of a network device, with parts repeated with the embodiments of the fifth aspect being not going to be described herein any further.

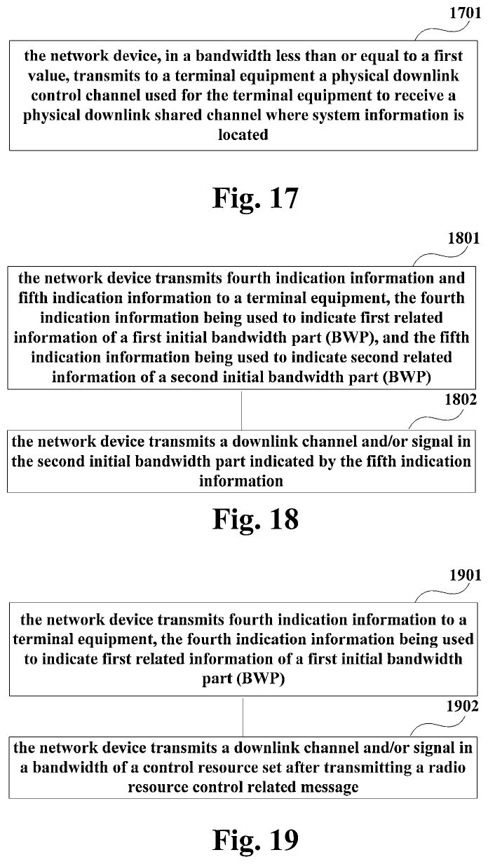

FIG. 17 is a schematic diagram of the data transmission method of the embodiment of this disclosure. As shown in FIG. 17, the method includes:

1701: the network device, in a bandwidth less than or equal to a first value, transmits to a terminal equipment a physical downlink control channel used for the terminal equipment to receive a physical downlink shared channel where system information is located.

In some embodiments, the first value is related to a maximum bandwidth capability of the terminal equipment, which may be in unit of MHz or the number of RBs, and the terminal equipment may be a terminal equipment with a small bandwidth capability (Redcap UE) (such as less than or equal to 50 MHz). For example, the maximum bandwidth capability of the terminal equipment is 50 MHz, and the terminal equipment does not expect that the bandwidth of the second control resource set is greater than 50 MHz, and the network device will not transmit a PDCCH to the terminal equipment in a bandwidth greater than 50 MHz.

In some embodiments, the second control resource set is control resource set 0, and the system information may be system information type 1 (SIB1). Reference may be made to the embodiments of the first aspect for details, which shall not be repeated herein any further.

In some embodiments, the bandwidth of the second control resource set configured by the network device is lower than or equal to the first value, for example, a bandwidth (such as the number of RBs) to which the second configuration information of the second control resource set configured in a master information block (MIB) corresponds is lower than or equal to the first value, and the second configuration information of the second control resource set corresponds to the first configuration information of the first control resource set in the embodiments of the first aspect, and repeated parts shall not be described herein any further.

It can be seen from the above embodiment that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

For example, in the embodiments, the network device will not transmit the PDCCH in a larger bandwidth, hence, the terminal equipment will not receive the PDCCH in a larger bandwidth, thereby enabling the terminal equipment with a smaller bandwidth capability to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Fourteenth Aspect

The embodiments of this disclosure provide a data transmission method, which shall be described from a side of a network device, with parts repeated with the embodiments of the sixth aspect being not going to be described herein any further.

FIG. 18 is a schematic diagram of the data transmission method of the embodiments of this disclosure. As shown in FIG. 18, the method includes:

1801: the network device transmits fourth indication information and fifth indication information to a terminal equipment, the fourth indication information being used to indicate first related information of a first initial bandwidth part (BWP), and the fifth indication information being used to indicate second related information of a second initial bandwidth part (BWP); and

1802: the network device transmits a downlink channel and/or signal in the second initial bandwidth part indicated by the fifth indication information.

In some embodiments, reference may be made to 1101-1102 in the embodiments of the sixth aspect for implementations of 1801-1802, which shall not be repeated herein any further.

In some embodiments, reference may be made to the embodiments of the sixth aspect for implementations of the fourth indication information, the fifth indication information, the first initial bandwidth part, the first related information, the second initial bandwidth part and the second related information, which shall not be repeated herein any further.

In some embodiments, the second initial bandwidth part covers the control resource set of the terminal equipment. The control resource set is a control resource set 0, such as the second control resource set in the previous embodiments. Reference may be made to the previous embodiments for a meaning of the control resource set 0, which shall not be repeated herein any further.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

For example, in the embodiments, with the newly-configured information of the second initial bandwidth part, the terminal equipment with a smaller bandwidth capability is enabled to correctly receive the downlink control channel and/or data channel in the second initial bandwidth part, such as a PDCCH and/or a PDSCH scheduled by the PDCCH, which is conducive to performing communications by a UE with a smaller bandwidth capability.

### Embodiments of a Fifteenth Aspect

The embodiments of this disclosure provide a data transmission method, which shall be described from a side of a network device, with parts repeated with the embodiments of the seventh aspect being not going to be described herein any further.

FIG. 19 is a schematic diagram of the data transmission method of the embodiment of this disclosure. As shown in FIG. 19, the method includes:

1901: the network device transmits fourth indication information to a terminal equipment, the fourth indication information being used to indicate first related information of a first initial bandwidth part (BWP); and

1902: the network device transmits a downlink channel and/or signal in a bandwidth of a control resource set after transmitting a radio resource control related message.

In some embodiments, reference may be made to 1201-1202 in the embodiments of the seventh aspect for implementations of 1901-1902, which shall not be repeated herein any further.

In some embodiments, reference may be made to the embodiments of the seventh aspect for implementations of the fourth indication information, the first initial bandwidth part and the first related information, which shall not be repeated herein any further.

In some embodiments, the second initial bandwidth part covers the control resource set of the terminal equipment. The control resource set is a control resource set 0, such as the second control resource set in the previous embodiments, and reference may be made to the previous embodiments for a meaning of the control resource set 0, which shall not be repeated herein any further.

In some embodiments, the network device may first configure the first related information of the first initial bandwidth part (initial BWP) in SIB1, and transmits the fourth indication information to the terminal equipment to indicate the first related information, so as to determine the first initial bandwidth part, and the terminal equipment continues to maintain the control resource set, until it receives radio resource control (RRC) related message transmitted by the network device, and continues to maintain the control resource set after receiving the radio resource control (RRC) related message, and the network device schedules the terminal equipment in the bandwidth of the control resource set, such as transmitting the downlink channel and/or signal. The control resource set may be the control resource set 0. Reference may be made to the second control resource set in the previous embodiments for a specific implementation, which shall not be repeated herein any further.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

For example, in the embodiments, the downlink channel and/or signal, etc., is/are received in the bandwidth of the control resource set after the radio resource control related message is received, instead of receiving the downlink channel and/or signal in the initial bandwidth part, thereby enabling the terminal equipment with a smaller bandwidth capability to correctly receive the PDCCH and/or the PDSCH scheduled by the PDCCH, which is conducive to performing communications by a UE with a smaller bandwidth capability.

### Embodiments of a Sixteenth Aspect

The embodiments of this disclosure provides a data transmission method, which shall be described from a side of a network device, with parts repeated with the embodiments of the eighth aspect being not going to be described herein any further.

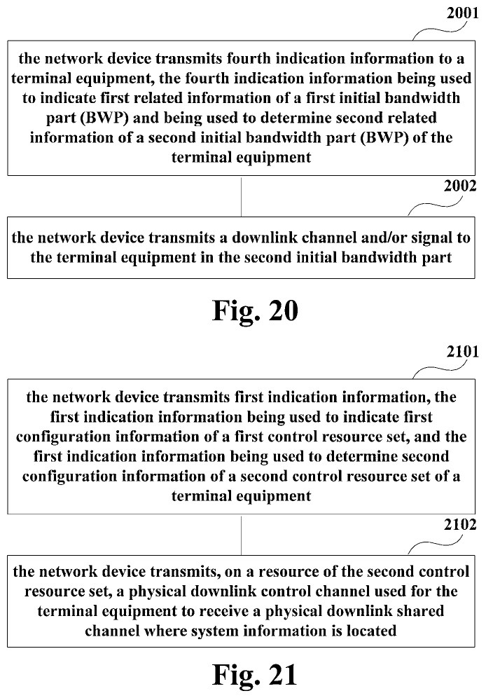

FIG. 20 is a schematic diagram of the data transmission method of the embodiments of this disclosure. As shown in FIG. 20, the method includes:

2001: the network device transmits fourth indication information to a terminal equipment, the fourth indication information being used to indicate first related information of a first initial bandwidth part (BWP) and being used to determine second related information of a second initial bandwidth part (BWP) of the terminal equipment; and

2002: the network device transmits a downlink channel and/or signal to the terminal equipment in the second initial bandwidth part.

In some embodiments, reference may be made to 1301-1302 in the embodiments of the eighth aspect for implementations of 2001-2002, which shall not be repeated herein any further.

In some embodiments, reference may be made to the embodiments of the eighth aspect for implementations of the fourth indication information, the first initial bandwidth part, the first related information, the second initial bandwidth part and the second related information, which shall not be repeated herein any further.

In some embodiments, the network device also determines the second related information of the second initial bandwidth part (initial BWP) of the terminal equipment according to the fourth indication information, and transmits the downlink channel and/or signal to the terminal equipment in the second initial bandwidth part. Reference may be made to the embodiments of the eighth aspect for a mode for determining the second related information, which shall not be repeated herein any further.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

For example, in the embodiments, the terminal equipment determines the related information of the second initial bandwidth part used thereby according to the related information of the first initial bandwidth part indicated by the indication information, and receives the downlink channel and/or signal in the second initial bandwidth part, instead of receiving the downlink channel and/or signal in the first initial bandwidth part, thereby enabling the terminal equipment with a smaller bandwidth capability to correctly receive the PDCCH and/or the PDSCH scheduled by the PDCCH in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Seventeenth Aspect

The embodiments of this disclosure provide a data reception apparatus. The apparatus may be, for example, a terminal equipment (such as a reduced capability terminal equipment), or may be one or more components or assemblies configured in a terminal equipment, with contents identical to those in the embodiments of the first aspect being not going to be described herein any further.

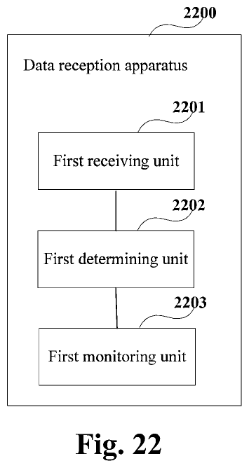

FIG. 22 is a schematic diagram of the data reception apparatus of the embodiment of this disclosure. As shown in FIG. 22, the data reception apparatus 2200 includes:

a first receiving unit 2201 configured to receive first indication information, the first indication information being used for indicating first configuration information of a first control resource set;

a first determining unit 2202 configured to determine second configuration information of a second control resource set of the terminal equipment according to the first indication information or a synchronization signal block (SSB) to which the first control resource set corresponds; and

a first monitoring unit 2203 configured to, on resources of the second control resource set, monitor a physical downlink control channel used for receiving a physical downlink shared channel where system information is located.

In some embodiments, reference may be made to 201-203 in the embodiments of the first aspect and 501-503 in the embodiments of the second aspect for implementations of the first receiving unit 2201, the first determining unit 2202 and the first monitoring unit 2203, and repeated parts shall not be described herein any further.

In some embodiments, the first determining unit 2202 determines a frequency-domain starting, or ending, or central location of the first control resource set according to the first indication information, and takes the frequency-domain starting, or ending, or central location of the first control resource set as a frequency-domain starting, or ending, or central location of the second control resource set, or performs offset on the frequency-domain starting, or ending, or central location of the first control resource set by a second offset value and takes the location after performing the offset as a frequency-domain starting, or ending, or central location of the second control resource set.

In some embodiments, when the first indication information is an index, the first determining unit 2202 takes an index obtained by performing a third offset value plus on an index of the first control resource set as an index of the second control resource set.

In some embodiments, the first determining unit 2202 takes a frequency-domain starting, or ending, or central location of the synchronization signal block (SSB) to which the first control resource set corresponds as a frequency-domain starting and/or ending and/or central location of the second control resource set, or performs offset on a frequency-domain starting and/or ending and/or central location of the synchronization signal block (SSB) to which the first control resource set corresponds by a fourth offset value and takes the location after performing offset as a frequency-domain starting and/or ending and/or central location of the second control resource set.

In some embodiments, the first determining unit 2202 is further configured to determine that a time-domain length of the second control resource set is less than or equal to a time-domain length of the first control resource set, or a time-domain length of the second control resource set is equal to a time-domain length to which the index of the second control resource set corresponds, or a frequency-domain bandwidth of the second control resource set is predefined or equal to a bandwidth to which the index of the second control resource set corresponds.

In some embodiments, the first indication information is contained in a master information block (MIB).

In some embodiments, the first configuration information includes at least one of a pattern multiplexed by the synchronization signal block and the first control resource set, frequency-domain bandwidth information, time-domain length information, and the first offset value of the frequency-domain between the first control resource set and the synchronization signal block.

In some embodiments, the terminal equipment is a reduced capability terminal equipment.

In some embodiments, the first control resource set and the second control resource set are control resource set 0 (CORESET 0), and reference may be made to the embodiments of the first aspect for a meaning of the control resource set 0, which shall not be described herein any further.

In some embodiments, the system information is of system information block type 1 (SIB1).

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data reception apparatus 2200 may further include other components or modules, and reference may be made to related techniques for particulars of these components or modules.

Furthermore, for the sake of simplicity, connection relationships between the components or modules or signal profiles thereof are only illustrated in FIG. 22. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of an Eighteenth Aspect

The embodiments of this disclosure provide a data reception apparatus. The apparatus may be, for example, a terminal equipment (such as a reduced capability terminal equipment), or may be one or more components or assemblies configured in a terminal equipment, with contents identical to those in the embodiments of the third aspect being not going to be described herein any further.

FIG. 23 is a schematic diagram of the data reception apparatus of the embodiments of this disclosure. As shown in FIG. 23, the data reception apparatus 2300 includes:

a second receiving unit 2301 configured to receive second indication information, the second indication information being used for indicating third configuration information of a first search space;

a second determining unit 2302 configured to determine fourth configuration information of a second search space of the terminal equipment according to the second indication information; and

a second monitoring unit 2303 configured to monitor in the second search space a physical downlink control channel used for receiving a physical downlink shared channel where system information is located.

In some embodiments, reference may be made to 701-703 in the embodiments of the third aspect for the second receiving unit 2301, the second determining unit 2302 and the second monitoring unit 2303, with repeated parts being not going to be described herein any further.

In some embodiments, when the second indication information is an index, the second determining unit 2302 takes the index obtained by performing a fifth offset value plus on an index indicated by the second indication information as the index of the second search space, or, determines the index of the second search space according to the index of the first search space and a predetermined relationship between the first search space index the and the second search space index.

In some embodiments, an occasion of monitoring the PDCCH in the second search space does not overlap with an occasion of monitoring the PDCCH in the first search space.

For example, the second determining unit 2302 takes the index indicated by the second indication information as the index of the second search space, and calculates a starting slot index monitoring a PDCCH in the second search space according to third configuration information to which an index indicated by the second indication information corresponds, performs offset on the starting slot index by a sixth offset value, and takes the index after performing offset as the starting slot index monitoring a PDCCH in the second search space;

or,

takes the index indicated by the second indication information as the index of the second search space and calculates a second system frame number of a radio frame where a slot monitoring a PDCCH is located in the second search space according to third configuration information to which an index indicated by the second indication information corresponds, the second system frame number not overlapping with a first system frame number of a radio frame where a slot monitoring a PDCCH is located in the first search space;

or,

calculates a first PDCCH monitoring occasion in the first search space according to third configuration information to which an index indicated by the second indication information corresponds, and third configuration information indicated by an index of a search space to which a selected second PDCCH monitoring occasion not overlapping with the first PDCCH monitoring occasion corresponds is taken as as fourth configuration information of the second search space.

In some embodiments, the second indication information is contained in a master information block (MIB).

In some embodiments, the first search space and the second search space are search space 0 (SS 0), and reference may be made to the embodiments of the third aspect for a meaning of search space 0, which shall not be described herein any further.

In some embodiments, the terminal equipment is a reduced capability terminal equipment.

In some embodiments, the system information is system information block type 1 (SIB1).

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data reception apparatus 2300 may further include other components or modules, and reference may be made to related techniques for particulars of these components or modules.

Furthermore, for the sake of simplicity, connection relationships between the components or modules or signal profiles thereof are only illustrated in FIG. 23. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Nineteenth Aspect

The embodiments of this disclosure provide a data reception apparatus. The apparatus may be, for example, a terminal equipment (such as a reduced capability terminal equipment), or may be one or more components or assemblies configured in a terminal equipment, with contents identical to those in the embodiments of the fourth aspect being not going to be described herein any further.

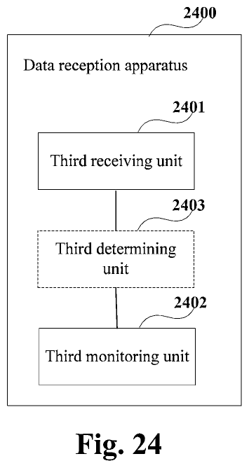

FIG. 24 is a schematic diagram of the data reception apparatus of the embodiment of this disclosure. As shown in FIG. 24, the data reception apparatus 2400 includes:

a third receiving unit 2401 configured to receive third indication information, the third indication information being used for indicating second configuration information of a second control resource set of the terminal equipment and/or indicating fourth configuration information of a second search space of the terminal equipment; and

a third monitoring unit 2402 configured to, on resources of the second control resource set and/or in the second search space, monitor physical downlink control channels used for receiving physical downlink shared channels where system information is located.

In some embodiments, reference may be made to 801-802 in the embodiments of the fourth aspect for the third receiving unit 2401 and the third monitoring unit 2402, and repeated parts being not going to be described herein any further.

In some embodiments, the third indication information is contained in a master information block (MIB).

In some embodiments, the third indication information is an information element with 1 bit.

In some embodiments, the apparatus may further include:

a third determining unit 2403 configured to determine the second configuration information of the second control resource set of the terminal equipment and/or the fourth configuration information indicating the second search space of the terminal equipment according to the third indication information and a correspondence between the third indication information and the second configuration information of the second control resource set of the terminal equipment and/or the fourth configuration information indicating the second search space of the terminal equipment.

In some embodiments, the terminal equipment is a reduced capability terminal equipment.

In some embodiments, the second search space is search space 0 (SS 0), the second control resource set is control resource set 0, and reference may be made to the embodiments of the first aspect for a meaning thereof, which shall not be described herein any further.

In some embodiments, the system information is system information block type 1 (SIB1).

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data reception apparatus 2400 may further include other components or modules, and reference may be made to related techniques for particulars of these components or modules.

Furthermore, for the sake of simplicity, connection relationships between the components or modules or signal profiles thereof are only illustrated in FIG. 24. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Twentieth Aspect

The embodiments of this disclosure provide a data reception apparatus. The apparatus may be, for example, a terminal equipment (such as a reduced capability terminal equipment), or may be one or more components or assemblies configured in a terminal equipment, with contents identical to those in the embodiments of the fifth aspect being not going to be described herein any further.

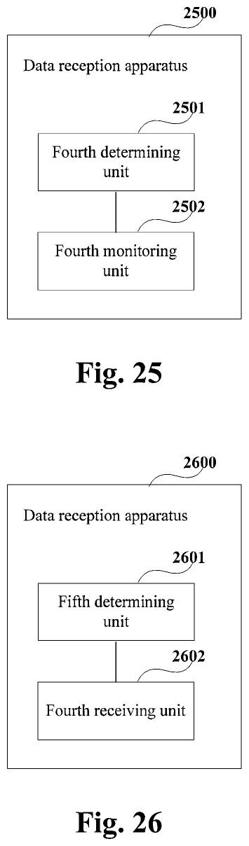

FIG. 25 is a schematic diagram of the data reception apparatus of the embodiment of this disclosure. As shown in FIG. 25, the data reception apparatus 2500 includes:

a fourth determining unit 2501 configured to determine a bandwidth of a second control resource set of the terminal equipment, the bandwidth being less than or equal to a first value; and

a fourth monitoring unit 2502 configured to monitor in the bandwidth of the second search space a physical downlink control channel used for receiving a physical downlink shared channel where system information is located.

In some embodiments, reference may be made to 901-902 in the embodiments of the fifth aspect for implementations of the fourth determining unit 2501 and the fourth monitoring unit 2502, and repeated parts shall not be described herein any further.

In some embodiments, the first value is related to a maximum bandwidth capability of the terminal equipment.

In some embodiments, a frequency-domain location of the physical downlink data channel indicated by the physical downlink control channel is within the bandwidth of the second control resource set.

In some embodiments, the terminal equipment is a reduced capability terminal equipment.

In some embodiments, the second control resource set is control resource set 0, and reference may be made to the embodiments of the first aspect for a meaning thereof, which shall not be repeated herein any further.

In some embodiments, the system information is system information block type 1 (SIB1).

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data reception apparatus 2500 may further include other components or modules, and reference may be made to related techniques for particulars of these components or modules.

Furthermore, for the sake of simplicity, connection relationships between the components or modules or signal profiles thereof are only illustrated in FIG. 25. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Twenty-First Aspect

The embodiments of this disclosure provide a data reception apparatus. The apparatus may be, for example, a terminal equipment (such as a reduced capability terminal equipment), or may be one or more components or assemblies configured in a terminal equipment, with contents identical to those in the embodiments of the sixth aspect being not going to be described herein any further.

FIG. 26 is a schematic diagram of the data reception apparatus of the embodiment of this disclosure. As shown in FIG. 26, the data reception apparatus 2600 includes:

a fifth determining unit 2601 configured to receive fourth indication information and fifth indication information transmitted by a network device, the fourth indication information being used to indicate first related information of a first initial bandwidth part (BWP), and the fifth indication information being used to indicate second related information of a second initial bandwidth part (BWP); and

a fourth receiving unit 2602 configured to receive a downlink channel and/or signal in the second initial bandwidth part indicated by the fifth indication information.

In some embodiments, reference may be made to 1101-1102 in the embodiments of the sixth aspect for implementations of the fifth determining unit 2601 and the fourth receiving unit 2602, and repeated parts shall not be described herein any further.

In some embodiments, the fourth indication information is contained in a system information block (such as SIB1) to indicate a location and bandwidth of the first initial bandwidth part (BWP).

In some embodiments, the fifth indication information is contained in a system information block (such as SIB1) to indicate second related information of a second initial bandwidth part (BWP) of a reduced capability terminal equipment, the second related information including an offset and/or a location and/or a bandwidth; wherein the offset indicates an offset between a starting, or ending, or central location of the second initial bandwidth part and a starting, or ending, or central location of the first initial bandwidth part. Reference may be made to the embodiments of the sixth aspect for details, which shall not be described herein any further.

In some embodiments, the fifth indication information is contained in a radio resource control related message. Reference may be made to the embodiments of the sixth aspect for details, which shall not be described herein any further.

In some embodiments, the second initial bandwidth part covers a control resource set of the terminal equipment. The control resource set may be control resource set 0, and the terminal equipment may be an RedCap UE. Reference may be made to the embodiments of the first aspect for details, which shall not be described herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data reception apparatus 2600 may further include other components or modules, and reference may be made to related techniques for particulars of these components or modules.

Furthermore, for the sake of simplicity, connection relationships between the components or modules or signal profiles thereof are only illustrated in FIG. 26. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Twenty-Second Aspect

The embodiments of this disclosure provide a data reception apparatus. The apparatus may be, for example, a terminal equipment (such as a reduced capability terminal equipment), or may be one or more components or assemblies configured in a terminal equipment, with contents identical to those in the embodiments of the seventh aspect being not going to be described herein any further.

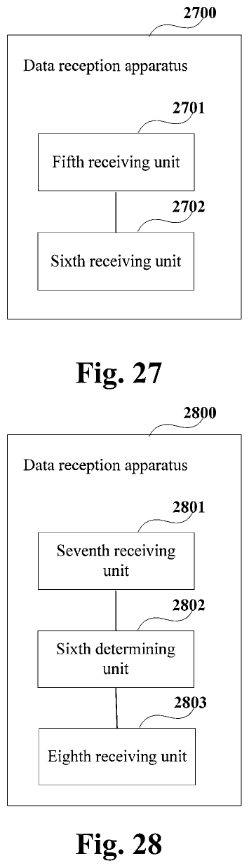

FIG. 27 is a schematic diagram of the data reception apparatus of the embodiment of this disclosure. As shown in FIG. 27, the data reception apparatus 2700 includes:

a fifth receiving unit 2701 configured to receive fourth indication information transmitted by a network device, the fourth indication information being used to indicate first related information of a first initial bandwidth part (BWP); and

a sixth receiving unit 2702 configured to receive a downlink channel and/or signal in a bandwidth of a control resource set after receiving a radio resource control related message.

In some embodiments, reference may be made to 1201-1202 in the embodiments of the seventh aspect for implementations of the fifth receiving unit 2701 and the sixth receiving unit 2702, and the repeated parts shall not be described herein any further.

In some embodiments, the fourth indication information is contained in a system information block to indicate a location and bandwidth of the first initial bandwidth part (BWP). The control resource set is control resource set 0, and reference may be made to the embodiments of the first aspect for details. And reference may be made to the embodiments of the seven aspect for the radio resource control related message, which shall not be described herein any further.

In some embodiments, the terminal equipment is a reduced capability terminal equipment.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data reception apparatus 2700 may further include other components or modules, and reference may be made to related techniques for particulars of these components or modules.

Furthermore, for the sake of simplicity, connection relationships between the components or modules or signal profiles thereof are only illustrated in FIG. 27. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Twenty-Third Aspect

The embodiments of this disclosure provides a data reception apparatus. The apparatus may be, for example, a terminal equipment (such as a reduced capability terminal equipment), or may be one or more components or assemblies configured in a terminal equipment, with contents identical to those in the embodiments of the eighth aspect being not going to be described herein any further.

FIG. 28 is a schematic diagram of the data reception apparatus of the embodiment of this disclosure. As shown in FIG. 28, the data reception apparatus 2800 includes:

a seventh receiving unit 2801 configured to receive fourth indication information transmitted by a network device, the fourth indication information being used to indicate first related information of a first initial bandwidth part (BWP);

a sixth determining unit 2802 configured to determine second related information of a second initial bandwidth part (BWP) of the terminal equipment according to the fourth indication information; and

an eighth receiving unit 2803 configured to receive a downlink channel and/or signal in the second initial bandwidth part.

In some embodiments, reference may be made to 1301-1303 in the embodiments of the eighth aspect for the seventh receiving unit 2801, the sixth determining unit 2802 and the eighth receiving unit 2803, and repeated parts shall not be described herein any further.

In some embodiments, the sixth determining unit 2802 takes an location obtained by performing offset on a frequency-domain starting, or ending, or central location of the first initial bandwidth part by an eighth offset value as a frequency-domain starting, or ending, or central location of the second initial bandwidth part.

In some embodiments, the second initial bandwidth part covers the control resource set of the terminal equipment, and the control resource set is a control resource set 0. Reference may be made to the embodiments of the first aspect for a meaning of the control resource set 0, which shall not be described herein any further.

In some embodiments, the terminal equipment is a reduced capability terminal equipment.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data reception apparatus 2800 may further include other components or modules, and reference may be made to related techniques for particulars of these components or modules.

Furthermore, for the sake of simplicity, connection relationships between the components or modules or signal profiles thereof are only illustrated in FIG. 28. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Twenty-Fourth Aspect

The embodiment of this disclosure provide a data transmission apparatus. The apparatus may be, for example, a network device, or may be one or more components or assemblies configured in a network device, with contents identical to those in the embodiments of the ninth and tenth aspects being not going to be described herein any further.

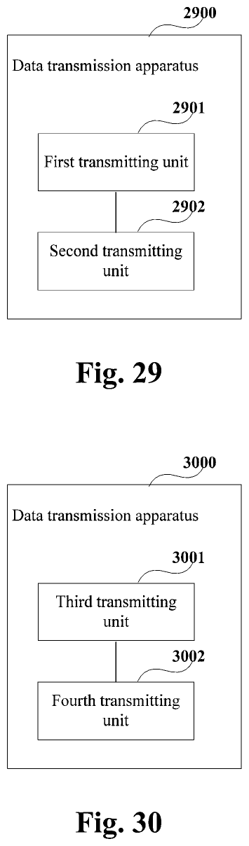

FIG. 29 is a schematic diagram of the data transmission apparatus of the embodiment of this disclosure. As shown in FIG. 29, the data transmission apparatus 2900 includes:

a first transmitting unit 2901 configured to transmit first indication information, the first indication information being used for indicating first configuration information of a first control resource set, and the first indication information or a synchronization signal block (SSB) corresponding to the first control resource set being used to determine second configuration information of a second control resource set of a terminal equipment; and

a second transmitting unit 2902 configured to, on a resource of the second control resource set, transmit a physical downlink control channel used for the terminal equipment to receive a physical downlink shared channel where system information is located.

In some embodiments, reference may be made to 2101-2102 in the embodiments of the ninth aspect and 1401-1402 in the embodiments of the tenth aspect for the first transmitting unit 2901 and the second transmitting unit 2902, and repeated parts shall not be described herein any further.

In some embodiments, reference may be made to the embodiments of the first aspect for the first indication information, the first control resource set, the first configuration information, the second control resource set and the second configuration information, and repeated parts shall not be described herein any further.

In some embodiments, the network device further includes a determining unit (not shown in figures) configured to determine the second configuration information of the second control resource set of the terminal equipment according to the first indication information or the synchronization signal block (SSB) corresponding to the first control resource set, and transmit on the resource of the second control resource set the physical downlink control channel used for the terminal equipment to receive a physical downlink shared channel where system information is located. Reference may be made to the embodiments of the first aspect for a mode for determining the second configuration information, which shall not be described herein any further.

In some embodiments, the second transmitting unit 2902 transmits a PDCCH to a reduced capability terminal equipment at a first time, and transmits a PDCCH to a non-reduced capability terminal equipment at a second time, the first time not overlapping the second time.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data reception apparatus 2900 may further include other components or modules, and reference may be made to related techniques for particulars of these components or modules.

Furthermore, for the sake of simplicity, connection relationships between the components or modules or signal profiles thereof are only illustrated in FIG. 29. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Twenty-Fifth Aspect

The embodiments of this disclosure provide a data transmission apparatus. The apparatus may be, for example, a network device, or may be one or more components or assemblies configured in a network device, with contents identical to those in the embodiments of the eleventh aspect being not going to be described herein any further.

FIG. 30 is a schematic diagram of the data transmission apparatus of the embodiment of this disclosure. As shown in FIG. 30, the data transmission apparatus 3000 includes:

a third transmitting unit 3001 configured to transmit second indication information, the second indication information being used to indicate third configuration information of a first search space, and the second indication information being used to determine fourth configuration information of a second search space of a terminal equipment; and

a fourth transmitting unit 3002 configured to transmit, in the second search space, a physical downlink control channel used for the terminal equipment to receive a physical downlink shared channel where system information is located.

In some embodiments, reference may be made to 1401-1402 in the embodiments of the eleventh aspect for implementations of the third transmitting unit 3001 and the fourth transmitting unit 3002, and repeated parts shall not be described herein any further.

In some embodiments, reference may be made to the embodiments of the second aspect for implementations of the first indication information, the first control resource set, the first configuration information, the second control resource set and the second configuration information, which shall not be described herein any further.

In some embodiments, the network device further includes a determining unit (not shown in figures) configured to determine the fourth configuration information of the second search space of the terminal equipment according to the second indication information, and transmit in the second search space the physical downlink control channel used for the terminal equipment to receive a physical downlink shared channel where system information is located. Reference may be made to the embodiments of the third aspect for a mode for determining the fourth configuration information, which shall not be described herein any further.

In some embodiments, the fourth transmitting unit 3002 transmits a PDCCH to a reduced capability terminal equipment (RedCap UE) at a first time, and transmits a PDCCH to a non-reduced capability terminal equipment at a second time, the first time and the second time being not overlapped.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data transmission apparatus 3000 may further include other components or modules, and reference may be made to related techniques for particulars of these components or modules.

Furthermore, for the sake of simplicity, connection relationships between the components or modules or signal profiles thereof are only illustrated in FIG. 30. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Twenty-Sixth Aspect

The embodiments of this disclosure provides a data transmission apparatus. The apparatus may be, for example, a network device, or may be one or more components or assemblies configured in a network device, with contents identical to those in the embodiments of the twelfth aspect being not going to be described herein any further.

FIG. 31 is a schematic diagram of the data transmission apparatus of the embodiment of this disclosure. As shown in FIG. 31, the data transmission apparatus 3100 includes:

a fifth transmitting unit 3101 configured to transmit third indication information, the third indication information being used for indicating second configuration information of a second control resource set of a terminal equipment and/or being used for indicating fourth configuration information of a second search space of a terminal equipment; and

a sixth transmitting unit 3102 configured to, on resources of the second control resource set and/or in the second search space, transmit a physical downlink control channel used for the terminal equipment to receive a physical downlink shared channel where system information is located.

In some embodiments, reference may be made to 1601-1602 in the embodiments of the twelfth aspect for implementations of the fifth transmitting unit 3101 and the sixth transmitting unit 3102, and repeated parts shall not be described herein any further.

In some embodiments, reference may be made to the embodiments of the previous three aspects for a meaning of the second control resource set and the second search space, reference may be made to the first configuration information of the first aspect for information in the second configuration information, and reference may be made to the third configuration information of the third aspect for information in the fourth configuration information, which shall not be described herein any further.

In some embodiments, reference may be made to the embodiments of the fourth aspect for implementation of the third indication information, which shall not be described herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data transmission apparatus 3100 may further include other components or modules, and reference may be made to related techniques for particulars of these components or modules.

Furthermore, for the sake of simplicity, connection relationships between the components or modules or signal profiles thereof are only illustrated in FIG. 31. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Twenty-Seventh Aspect

The embodiments of this disclosure provide a data transmission apparatus. The apparatus may be, for example, a network device, or may be one or more components or assemblies configured in a network device, with contents identical to those in the embodiments of the thirteenth aspect being not going to be described herein any further.

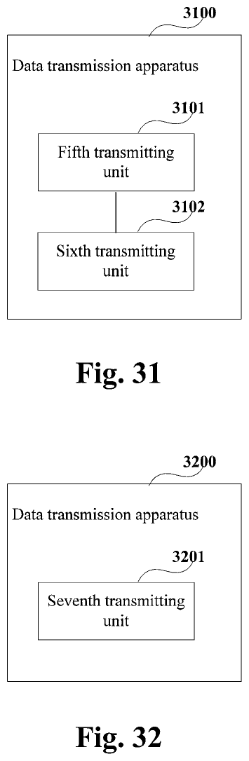

FIG. 32 is a schematic diagram of the data transmission apparatus of the embodiment of this disclosure. As shown in FIG. 32, the data transmission apparatus 3200 includes:

a seventh transmitting unit 3201 configured to transmit to a terminal equipment in a bandwidth less than or equal to a first value, a physical downlink control channel used for the terminal equipment to receive a physical downlink shared channel where system information is located.

In some embodiments, reference may be made to 1701 in the embodiments of the thirteenth aspect for implementation of the seventh transmitting unit 3201, which shall not be described herein any further.

In some embodiments, the terminal equipment is a reduced capability terminal equipment.

In some embodiments, the first value is related to a maximum bandwidth capability of the terminal equipment, and the terminal equipment may be a terminal equipment with a small bandwidth capability (Redcap UE) (such as less than or equal to 50 MHz). For example, the maximum bandwidth capability of the terminal equipment is 50 MHz, and the terminal equipment does not expect that the bandwidth of the second control resource set is greater than 50 MHz, and the seventh transmitting unit 3201 will not transmit a PDCCH to the terminal equipment in a bandwidth greater than 50 MHz.

In some embodiments, the second control resource set is control resource set 0, and the system information may be system information type 1 (SIB1). Reference may be made to the embodiments of the first aspect for details, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data transmission apparatus 3200 may further include other components or modules, and reference may be made to related techniques for particulars of these components or modules.

Furthermore, for the sake of simplicity, connection relationships between the components or modules or signal profiles thereof are only illustrated in FIG. 32. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Twenty-Eighth Aspect

The embodiments of this disclosure provide a data transmission apparatus. The apparatus may be, for example, a network device, or may be one or more components or assemblies configured in a network device, with contents identical to those in the embodiments of the fourteenth aspect being not going to be described herein any further.

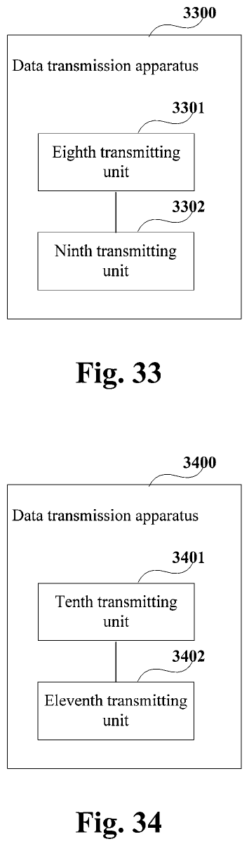

FIG. 33 is a schematic diagram of the data transmission apparatus of the embodiment of this disclosure. As shown in FIG. 33, the data transmission apparatus 3300 includes:

an eighth transmitting unit 3301 configured to transmit fourth indication information and fifth indication information to a terminal equipment, the fourth indication information being used to indicate first related information of a first initial bandwidth part (BWP), and the fifth indication information being used to indicate second related information of a second initial bandwidth part (BWP); and

a ninth transmitting unit 3302 configured to transmit a downlink channel and/or signal in the second initial bandwidth part indicated by the fifth indication information. In some embodiments, reference may be made to 1801-1802 in the embodiments of the fourteenth aspect for implementations of the eighth transmitting unit 3301 and the ninth transmitting unit 3302, which shall not be repeated herein any further.

In some embodiments, reference may be made to the embodiments of the sixth aspect for implementations of the fourth indication information and the fifth indication information, the first initial bandwidth part, the first related information, the second initial bandwidth part and the second related information, which shall not be repeated herein any further.

In some embodiments, the second initial bandwidth part covers the control resource set of the terminal equipment. The control resource set is a control resource set 0, such as the second control resource set in the previous embodiments. Reference may be made to the previous embodiments for a meaning of the control resource set 0, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data transmission apparatus 3300 may further include other components or modules, and reference may be made to related techniques for particulars of these components or modules.

Furthermore, for the sake of simplicity, connection relationships between the components or modules or signal profiles thereof are only illustrated in FIG. 33. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Twenty-Ninth Aspect

The embodiments of this disclosure provide a data transmission apparatus. The apparatus may be, for example, a network device, or may be one or more components or assemblies configured in a network device, with contents identical to those in the embodiments of the fifteenth aspect being not going to be described herein any further.

FIG. 34 is a schematic diagram of the data transmission apparatus of the embodiment of this disclosure. As shown in FIG. 34, the data transmission apparatus 3400 includes:

a tenth transmitting unit 3401 configured to transmit fourth indication information to a terminal equipment, the fourth indication information being used to indicate first related information of a first initial bandwidth part (BWP); and

an eleventh transmitting unit 3402 configured to transmit a downlink channel and/or signal in a bandwidth of a control resource set after transmitting a radio resource control related message.

In some embodiments, reference may be made to 1901-1902 in the embodiments of the fifteenth aspect for implementations of the tenth transmitting unit 3401 and the eleventh transmitting unit 3402, which shall not be repeated herein any further.

In some embodiments, reference may be made to the embodiments of the seventh aspect for implementations of the fourth indication information, the first initial bandwidth part and the first related information, which shall not be repeated herein any further.

In some embodiments, the second initial bandwidth part covers the control resource set of the terminal equipment. The control resource set is a control resource set 0, such as the second control resource set in the previous embodiments, and reference may be made to the previous embodiments for a meaning of the control resource set 0, which shall not be repeated herein any further.

In some embodiments, the network device may further include a configuring unit (not shown in figures) configured to first configure the first related information of the first initial bandwidth part (initial BWP) in SIB1, and the tenth transmitting unit 3401 transmits the fourth indication information to the terminal equipment to indicate the first related information, so as to determine the first initial bandwidth part, and the terminal equipment continues to maintain the control resource set, until it receives radio resource control (RRC) related message transmitted by the network device, and continues to maintain the control resource set after receiving the radio resource control (RRC) related message, and the eleventh transmitting unit 3402 schedules the terminal equipment in the bandwidth of the control resource set, such as transmitting the downlink channel and/or signal. The control resource set may be the control resource set 0. Reference may be made to the second control resource set in the previous embodiments for a specific implementation, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data transmission apparatus 3400 may further include other components or modules, and reference may be made to related techniques for particulars of these components or modules.

Furthermore, for the sake of simplicity, connection relationships between the components or modules or signal profiles thereof are only illustrated in FIG. 34. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Thirtieth Aspect

The embodiments of this disclosure provide a data transmission apparatus. The apparatus may be, for example, a network device, or may be one or more components or assemblies configured in a network device, with contents identical to those in the embodiments of the sixteenth aspect being not going to be described herein any further.

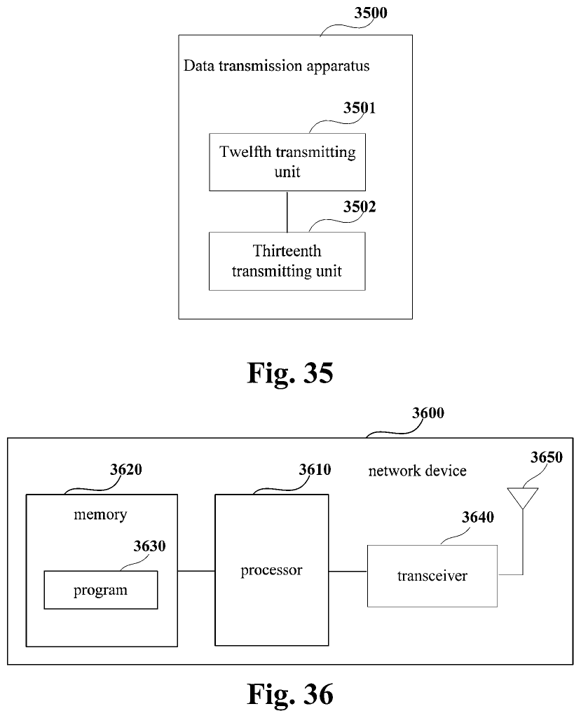

FIG. 35 is a schematic diagram of the data transmission apparatus of the embodiment of this disclosure. As shown in FIG. 35, the data transmission apparatus 3400 includes:

a twelfth transmitting unit 3501 configured to transmit fourth indication information to a terminal equipment, the fourth indication information being used to indicate first related information of a first initial bandwidth part (BWP) and being used to determine second related information of a second initial bandwidth part (BWP) of the terminal equipment; and

a thirteenth transmitting unit 3502 configured to transmit a downlink channel and/or signal to the terminal equipment in the second initial bandwidth part.

In some embodiments, reference may be made to 2001-2002 in the embodiments of the sixteenth aspect for implementations of the twelfth transmitting unit 3501 and the thirteenth transmitting unit 3502, which shall not be repeated herein any further.

In some embodiments, reference may be made to the embodiments of the eighth aspect for implementations of the fourth indication information, the first initial bandwidth part, the first related information, the second initial bandwidth part and the second related information, which shall not be repeated herein any further.

In some embodiments, the network device further includes a determining unit (not shown in figures) configured to determine the second related information of the second initial bandwidth part (initial BWP) of the terminal equipment according to the fourth indication information, and transmit the downlink channel and/or signal to the terminal equipment in the second initial bandwidth part. Reference may be made to the embodiments of the eighth aspect for a mode for determining the second related information, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data transmission apparatus 3500 may further include other components or modules, and reference may be made to related techniques for particulars of these components or modules.

Furthermore, for the sake of simplicity, connection relationships between the components or modules or signal profiles thereof are only illustrated in FIG. 35. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the terminal equipment with a smaller bandwidth capability is enabled to correctly receive the downlink control channel and/or data channel in the cell with a larger bandwidth, which is conducive to the access of the terminal equipment with a smaller bandwidth capability in the co-existence scenario of the terminal equipment with a smaller bandwidth capability and a related terminal equipment. In addition, there is no impact on behaviors of the related terminal equipment, and the implementation complexity is low.

### Embodiments of a Thirty-First Aspect

The embodiments of this disclosure provide a communication system, and reference may be made to FIG. 1, with contents identical to those in the embodiments of the first to the thirtieth aspects being not going to be described herein any further.

In some embodiments, the communication system 100 may at least include a terminal equipment 102 and a network device 101.

In some embodiments, the network device 101 transmits first indication information, the first indication information being used to indicate first configuration information of a first control resource set, and transmits a physical downlink control channel used for the terminal equipment to receive a physical downlink shared channel where system information is located in a bandwidth of a second control resource set. The terminal equipment 102 receives the first indication information and determines second configuration information of a second control resource set of the terminal equipment according to the first indication information or a synchronization signal block (SSB) corresponding to the first control resource set, and on a resource of the second control resource set, monitors the physical downlink control channel.

In some embodiments, the network device 101 transmits second indication information, the second indication information being used to indicate third configuration information of the first search space, and transmits a physical downlink control channel used for the terminal equipment to receive a physical downlink shared channel where system information is located in a second search space. The terminal equipment 102 receives the second indication information, and determines fourth configuration information of the second search space of the terminal equipment according to the second indication information, and monitors the physical downlink control channel in the second search space.

In some embodiments, the network device 101 transmits third indication information, the third indication information being used to indicate second configuration information of a second control resource set of the terminal equipment and/or indicate fourth configuration information of a second search space, transmits a physical downlink control channel used for the terminal equipment to receive a physical downlink shared channel where system information is located on a resource of the second control resource set and/or in the second search space. The terminal equipment 102 receives the third indication information, and monitors the physical downlink control channel on the resource of the second control resource set and/or in the second search space.

In some embodiments, the network device 101 transmits to a terminal equipment a physical downlink control channel used for the terminal equipment to receive a physical downlink shared channel where system information is located in a bandwidth less than or equal to a first value. The terminal equipment 102 determines a bandwidth of the second control resource set of the terminal equipment, the bandwidth being less than or equal to the first value, and monitors the physical downlink control channel used for the terminal equipment to receive a physical downlink shared channel where system information is located in the bandwidth of the second control resource set.

In some embodiments, the network device 101 transmits fourth indication information and fifth indication information to the terminal equipment, the fourth indication information being used to indicate first related information of the first initial bandwidth part (initial BWP), and the fifth indication information being used to indicate second related information of the second initial bandwidth part (initial BWP), and transmits a downlink channel and/or signal in the second initial bandwidth part indicated by the fifth indication information. The terminal equipment 102 receives the fourth indication information and fifth indication information transmitted by the network device, and receives the downlink channel and/or signal in the second initial bandwidth part indicated by the fifth indication information.

In some embodiments, the network device 101 transmits fourth indication information to the terminal equipment, the fourth indication information being used to indicate first related information of the first initial bandwidth part (initial BWP), transmits a downlink channel and/or signal in the bandwidth of the control resource set after transmitting a radio resource control related message. The terminal equipment 102 receives the fourth indication information transmitted by the network device, and receives the downlink channel and/or signal in the bandwidth of the control resource set after receiving the radio resource control related message.

In some embodiments, the network device 101 transmits fourth indication information to the terminal equipment, the fourth indication information being used to indicate first related information of a first initial bandwidth part (initial BWP), and transmits a downlink channel and/or signal to the terminal equipment in a second initial bandwidth part. The terminal equipment 102 receives the fourth indication information transmitted by the network device, determines second related information of a second initial bandwidth part (initial BWP) of the terminal equipment according to the fourth indication information, and receives the downlink channel and/or signal in the second initial bandwidth part.

The embodiments of this disclosure further provides a network device, which may be, for example, a base station; however, this disclosure is not limited thereto, and it may also be another network device.

FIG. 36 is a schematic diagram of a structure of the network device of the embodiment of this disclosure. As shown in FIG. 36, the network device 3600 may include a processor 3610 (such as a central processing unit (CPU)) and a memory 3620, the memory 3620 being coupled to the processor 3610. The memory 3620 may store various data, and furthermore, it may store a program 3630 for information processing, and execute the program 3630 under control of the processor 3610.

For example, the processor 3610 may be configured to execute a program to carry out the data transmission methods as described in the embodiments of the ninth to sixteenth aspects. For example, the processor 3610 may be configured to execute the following control: transmitting first indication information, the first indication information being used to indicate first configuration information of a first control resource set, and the first indication information or synchronization signal block (SSB) corresponding to the first control resource set being used to determine second configuration information of a second control resource set of a terminal equipment; and on a resource of the second control resource set, transmitting a physical downlink control channel used for the terminal equipment to receive a physical downlink shared channel where system information is located.

For example, the processor 3610 may be configured to execute the following control: transmitting second indication information, the second indication information being used to indicate third configuration information of a first search space, and the second indication information being used to determine fourth configuration information of a second search space of a terminal equipment; and transmitting a physical downlink control channel used for the terminal equipment to receive a physical downlink shared channel where system information is located in the second search space.

For example, the processor 3610 may be configured to execute the following control: transmitting third indication information, the third indication information being used for indicating second configuration information of a second control resource set of a terminal equipment and/or being used for indicating fourth configuration information of a second search space of a terminal equipment; and on resources of the second control resource set and/or in the second search space, transmitting a physical downlink control channel used for the terminal equipment to receive a physical downlink shared channel where system information is located.

For example, the processor 3610 may be configured to execute the following control: transmitting to a terminal equipment in a bandwidth less than or equal to a first value, a physical downlink control channel used for the terminal equipment to receive a physical downlink shared channel where system information is located.

For example, the processor 3610 may be configured to execute the following control: transmitting fourth indication information and fifth indication information to a terminal equipment, the fourth indication information being used to indicate first related information of a first initial bandwidth part (BWP), and the fifth indication information being used to indicate second related information of a second initial bandwidth part (BWP); and transmitting a downlink channel and/or signal in the second initial bandwidth part indicated by the fifth indication information.

For example, the processor 3610 may be configured to execute the following control: transmitting fourth indication information to a terminal equipment, the fourth indication information being used to indicate first related information of a first initial bandwidth part (BWP); and transmitting a downlink channel and/or signal in a bandwidth of a control resource set after transmitting a radio resource control related message.

For example, the processor 3610 may be configured to execute the following control: transmitting fourth indication information to a terminal equipment, the fourth indication information being used to indicate first related information of a first initial bandwidth part (BWP) and being used to determine second related information of a second initial bandwidth part (BWP) of the terminal equipment; and transmitting a downlink channel and/or signal to the terminal equipment in the second initial bandwidth part.

Furthermore, as shown in FIG. 36, the network device 3600 may include a transceiver 3640, and an antenna 3650, etc. Wherein, functions of the above components are similar to those in the related art, and shall not be described herein any further. It should be noted that the network device 3600 does not necessarily include all the parts shown in FIG. 36, and furthermore, the network device 3600 may include parts not shown in FIG. 36, and the related art may be referred to.

The embodiments of this disclosure further provides a terminal equipment; however, this disclosure is not limited thereto, and it may also be another equipment.

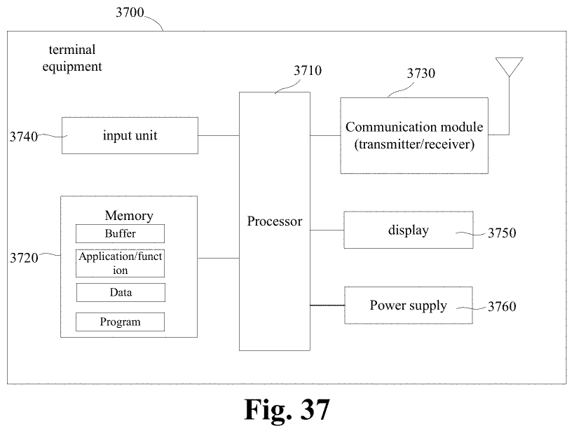

FIG. 37 is a schematic diagram of the terminal equipment of the embodiment of this disclosure. As shown in FIG. 37, the terminal equipment 3700 may include a processor 3710 and a memory 3720, the memory 3720 storing data and a program and being coupled to the processor 3710. It should be noted that this figure is illustrative only, and other types of structures may also be used, so as to supplement or replace this structure and achieve a telecommunications function or other functions.

For example, the processor 3710 may be configured to execute a program to carry out the data reception methods as described in the embodiments of the first to the eighth aspects. For example, the processor 3710 may be configured to perform the following control: receiving first indication information, the first indication information being used for indicating first configuration information of a first control resource set; determining second configuration information of a second control resource set of the terminal equipment according to the first indication information or synchronization signal block (SSB) corresponding to the first control resource set; and on resources of the second control resource set, monitoring a physical downlink control channel used for receiving a physical downlink shared channel where system information is located.

For example, the processor 3710 may be configured to perform the following control: receiving second indication information, the second indication information being used for indicating third configuration information of a first search space; determining fourth configuration information of a second search space of the terminal equipment according to the second indication information; and monitoring in the second search space a physical downlink control channel used for receiving a physical downlink shared channel where system information is located.

For example, the processor 3710 may be configured to perform the following control: receiving third indication information, the third indication information being used for indicating second configuration information of a second control resource set of the terminal equipment and/or indicating fourth configuration information of a second search space of the terminal equipment; and on resources of the second control resource set and/or in the second search space, monitoring physical downlink control channels used for receiving physical downlink shared channels where system information is located.

For example, the processor 3710 may be configured to perform the following control: determining a bandwidth of a second control resource set of the terminal equipment, the bandwidth being less than or equal to a first value; and monitoring in the bandwidth of the second search space a physical downlink control channel used for receiving a physical downlink shared channel where system information is located.

For example, the processor 3710 may be configured to perform the following control: receiving fourth indication information and fifth indication information transmitted by a network device, the fourth indication information being used to indicate first related information of a first initial bandwidth part (BWP), and the fifth indication information being used to indicate second related information of a second initial bandwidth part (BWP); and receiving a downlink channel and/or signal in the second initial bandwidth part indicated by the fifth indication information.

For example, the processor 3710 may be configured to perform the following control: receiving fourth indication information transmitted by a network device, the fourth indication information being used to indicate first related information of a first initial bandwidth part (BWP); and receiving a downlink channel and/or signal in a bandwidth of a control resource set after receiving a radio resource control related message.

For example, the processor 3710 may be configured to perform the following control: receiving fourth indication information transmitted by a network device, the fourth indication information being used to indicate first related information of a first initial bandwidth part (BWP); determining second related information of a second initial bandwidth part (BWP) of the terminal equipment according to the fourth indication information; and receiving a downlink channel and/or signal in the second initial bandwidth part.

As shown in FIG. 37, the terminal equipment 3700 may further include a communication module 3730, an input unit 3740, a display 3750, and a power supply 3760; wherein functions of the above components are similar to those in the related art, which shall not be described herein any further. It should be noted that the terminal equipment 3700 does not necessarily include all the parts shown in FIG. 37, and the above components are not necessary. Furthermore, the terminal equipment 3700 may include parts not shown in FIG. 37, and the related art may be referred to.

An embodiment of this disclosure provides a computer program, which, when executed in a terminal equipment, will cause the terminal equipment to carry out the data reception methods as described in the embodiments of the first to eighth aspects.

An embodiment of this disclosure provides a storage medium, including a computer program, which will cause a terminal equipment to carry out the data reception methods as described in the embodiments of the first to eighth aspects.

An embodiment of this disclosure provides a computer program, which, when executed in a network device, will cause the network device to carry out the data transmission methods as described in the embodiments of the ninth to sixteenth aspects.

An embodiment of this disclosure provides a storage medium, including a computer program, which will cause a network device to carry out the data transmission methods as described in the embodiments of the ninth to sixteenth aspects.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

As to implementations containing the above embodiments, following supplements are further disclosed.

1. A data reception method, applicable to a terminal equipment, the method comprising:

receiving first indication information by the terminal equipment, the first indication information being used for indicating first configuration information of a first control resource set;

determining, by the terminal equipment, second configuration information of a second control resource set of the terminal equipment according to the first indication information or synchronization signal block (SSB) corresponding to the first control resource set; and

on resources of the second control resource set, monitoring a physical downlink control channel used for receiving a physical downlink shared channel where system information is located.

2. The method according to supplement 1, wherein the determining second configuration information of a second control resource set according to the first indication information includes:

determining a frequency-domain starting or ending or central location of the first control resource set according to the first indication information; and

taking the frequency-domain starting or ending or central location of the first control resource set as the frequency-domain starting or ending or central location of the second control resource set; or, taking a location obtained by performing offset on the frequency-domain starting or ending or central location of the first control resource set by a second offset value as a frequency-domain starting or ending or central location of the second control resource set.

3. The method according to supplement 1, wherein when the first indication information is an index, the determining second configuration information of a second control resource set according to the first indication information includes:

takes an index obtained by performing a third offset value plus on an index of the first control resource set as an index of the second control resource set.

4. The method according to supplement 1, wherein the determining second configuration information of a second control resource set according to a synchronization signal block corresponding to the first control resource set includes:

taking a frequency-domain starting and/or ending and/or central location(s) of the SSB corresponding to the first control resource set as the frequency-domain starting and/or ending and/or central location(s) of the second control resource set; or, taking a location/locations obtained by performing offset by a fourth offset value on the frequency-domain starting and/or ending and/or central location(s) of the SSB corresponding to the first control resource set as the frequency-domain starting and/or ending and/or central location(s) of the second control resource set.

5. The method according to any one of supplements 1-4, wherein the determining second configuration information of a second control resource set of the terminal equipment by the terminal equipment according to the first indication information further includes:

a time-domain length of the second control resource set is less than or equal to a time-domain length of the first control resource set;

or, a time-domain length of the second control resource set is equal to a time-domain length to which an index of the second control resource set corresponds;

or, a frequency-domain bandwidth of the second control resource set is predefined or is equal to a bandwidth to which an index of the second control resource set corresponds.

6. The method according to any one of supplements 1-5, wherein the first indication information is contained in a master information block (MIB).

7. The method according to any one of supplements 1-6, wherein the first configuration information includes at least one of a pattern multiplexed by the synchronization signal block and the first control resource set, frequency-domain bandwidth information, time-domain length information, and the first offset value of the frequency-domain between the first control resource set and the SSB.

8. The method according to any one of supplements 1-7, wherein the terminal equipment is a reduced capability terminal equipment.

9. The method according to any one of supplements 1-8, wherein the first control resource set and the second control resource set are control resource set 0 (coreset 0).

10. The method according to any one of supplements 1-9, wherein the system information is system information block type 1 (SIB1).

11. A data reception method, applicable to a terminal equipment, the method comprising: receiving second indication information by the terminal equipment, the second indication information being used for indicating third configuration information of a first search space;

determining fourth configuration information of a second search space of the terminal equipment by the terminal equipment according to the second indication information; and

monitoring by the terminal equipment in the second search space a physical downlink control channel used for receiving a physical downlink shared channel where system information is located.

12. The method according to supplement 11, wherein when the second indication information is an index, the determining fourth configuration information of a second search space of the terminal equipment by the terminal equipment according to the second indication information comprises:

taking an index obtained by performing a fifth offset value plus on an index indicated by the second indication information as an index of the second search space; or

determining an index of the second search space according to an index of the first search space and a predetermined relationship between the index of the first search space and the index of the second search space.

13. The method according to supplement 11, wherein the determining fourth configuration information of a second search space of the terminal equipment according to the second indication information comprises:

not overlapping a occasion of monitoring a PDCCH in the second search space with a occasion of monitoring a PDCCH in the first search space.

14. The method according to supplement 13, wherein the not overlapping comprises:

taking the index indicated by the second indication information as the index of the second search space, calculating a starting slot index monitoring a PDCCH in the second search space according to third configuration information to which an index indicated by the second indication information corresponds, performing offset on the starting slot index by a sixth offset value and taking the index after performing offset as the starting slot index monitoring a PDCCH in the second search space;

or,

taking the index indicated by the second indication information as the index of the second search space, calculating a second system frame number of a radio frame where a slot monitoring a PDCCH is located in the second search space according to third configuration information to which an index indicated by the second indication information corresponds, the second system frame number not overlapping with a first system frame number of a radio frame where a slot monitoring a PDCCH is located in the first search space;

or,

calculating a first PDCCH monitoring occasion in the first search space according to third configuration information to which an index indicated by the second indication information corresponds, and third configuration information indicated by an index of a search space to which a selected second PDCCH monitoring occasion not overlapping with the first PDCCH monitoring occasion corresponds is taken as fourth configuration information of the second search space.

15. The method according to any one of supplements 11-14, wherein the second indication information is contained in a master information block (MIB).

16. The method according to any one of supplements 11-15, wherein the terminal equipment is a reduced capability terminal equipment.

17. The method according to any one of supplements 11-16, wherein the first search space and the second search space are search spaces 0 (SS0).

18. The method according to any one of supplements 11-17, wherein the system information is of system information block type 1 (SIB1).

19. A data reception method, applicable to a terminal equipment, the method comprising:

receiving third indication information by the terminal equipment, the third indication information being used for indicating second configuration information of a second control resource set of the terminal equipment and/or indicating fourth configuration information of a second search space of the terminal equipment; and

on resources of the second control resource set and/or in the second search space, monitoring by the terminal equipment physical downlink control channels used for receiving physical downlink shared channels where system information is located.

20. The method according to supplement 19, wherein the third indication information is contained in a master information block (MIB).

21. The method according to supplement 19, wherein the third indication information is an information element with 1 bit.

22. The method according to supplement 19, wherein the method further comprises:

determining second configuration information of the second control resource set of the terminal equipment and/or fourth configuration information indicating the second search space of the terminal equipment by the terminal equipment according to the third indication information and a corresponding relationship between the third indication information and the second configuration information of the second control resource set of the terminal equipment and/or the fourth configuration information indicating the second search space of the terminal equipment.

23. The method according to any one of supplements 19-22, wherein the terminal equipment is a reduced capability terminal equipment.

24. The method according to any one of supplements 19-23, wherein the second search space is a search space 0 (SS0), and the second control resource set is a control resource set 0.

25. The method according to any one of supplements 19-24, wherein the system information is of system information block type 1 (SIB1).

26. A data reception method, applicable to a terminal equipment, the method comprising:

determining a bandwidth of a second control resource set of the terminal equipment by the terminal equipment, the bandwidth being less than or equal to a first value; and

monitoring by the terminal equipment in the bandwidth of the second search space a physical downlink control channel used for receiving a physical downlink shared channel where system information is located.

27. The method according to supplement 26, wherein the first value is related to a maximum bandwidth capability of the terminal equipment.

28. The method according to supplement 26, wherein a frequency-domain location of a physical downlink data channel indicated by the physical downlink control channel is in the bandwidth of the second control resource set.

29. The method according to any one of supplements 26-28, wherein the terminal equipment is a reduced capability terminal equipment.

30. The method according to any one of supplements 26-29, wherein the second control resource set is a control resource set 0 (CORESET 0).

31. The method according to any one of supplements 26-30, wherein the system information is of system information block type 1 (SIB1).

32. A data reception method, applicable to a terminal equipment, the method comprising:

receiving, by the terminal equipment, fourth indication information and fifth indication information transmitted by a network device, the fourth indication information being used to indicate first related information of a first initial bandwidth part (BWP), and the fifth indication information being used to indicate second related information of a second initial bandwidth part (BWP); and

receiving, by the terminal equipment, a downlink channel and/or signal in the second initial bandwidth part indicated by the fifth indication information.

33. The method according to supplement 32, wherein the fourth indication information is contained in system information and used to indicate a location and bandwidth of the first initial BWP.

34. The method according to supplement 32 or 33, wherein the fifth indication information is contained in the system information, and is used to indicate second related information of a second initial bandwidth part (BWP) of a reduced capability terminal equipment, the second related information including an offset and/or a location and/or a bandwidth; wherein the offset denotes an offset between a starting or ending or central location of the second initial bandwidth part and a starting or ending or central location of the first initial bandwidth part.

35. The method according to supplement 32 or 33, wherein the fifth indication information is contained in a radio resource control related message.

36. The method according to any one of supplements 32-35, wherein the second initial bandwidth part covers the control resource set of the terminal equipment.

37. A data reception method, applicable to a terminal equipment, the method comprising:

receiving by the terminal equipment fourth indication information transmitted by a network device, the fourth indication information being used to indicate first related information of a first initial bandwidth part (BWP); and

receiving a downlink channel and/or signal in a bandwidth of a control resource set by the terminal equipment after receiving a radio resource control related message.

38. The method according to claim 37, wherein the fourth indication information is contained in a system information block to indicate a location and bandwidth of the first initial bandwidth part (BWP).

39. A data reception method, applicable to a terminal equipment, the method comprising:

receiving by the terminal equipment fourth indication information transmitted by a network device, the fourth indication information being used to indicate first related information of a first initial bandwidth part (BWP);

determining second related information of a second initial bandwidth part (BWP) of the terminal equipment by the terminal equipment according to the fourth indication information; and

receiving a downlink channel and/or signal in the second initial bandwidth part by the terminal equipment.

40. The method according to claim 39, wherein the determining second related information of a second initial bandwidth part (BWP) of the terminal equipment by the terminal equipment according to the fourth indication information comprises:

performing offset on a frequency-domain starting or ending or central location of the first initial bandwidth part by an eighth offset value, and taking the location after performing offset as a frequency-domain starting or ending or central location of the second initial bandwidth part.

41. The method according to claim 39 or 40, wherein the second initial bandwidth part covers a control resource set of the terminal equipment.

42. The method according to any one of supplements 36-38 and 41, wherein the control resource set is a control resource set 0, and in a bandwidth of the control resource set 0, the terminal equipment monitors a physical downlink control channel used for receiving a physical downlink shared channel where system information is located.

43. The method according to supplement 33 or 34 or 38 or 42, wherein the system information is of system information type 1.

44. The method according to any one of supplements 32-43, wherein the terminal equipment is a reduced capability terminal equipment.

45. A data transmission method, applicable to a network device, the method comprising:

transmitting first indication information by the network device, the first indication information being used to indicate first configuration information of a first control resource set, and the first indication information or a synchronization signal block corresponding to the first control resource set being used to determine second configuration information of a second control resource set of a terminal equipment; and

on a resource of the second control resource set, transmitting by the network device a physical downlink control channel used for the terminal equipment to receive a physical downlink shared channel where system information is located.

46. A data transmission method, applicable to a network device, the method comprising:

transmitting second indication information by the network device, the second indication information being used to indicate third configuration information of a first search space, and the second indication information being used to determine fourth configuration information of a second search space of a terminal equipment; and

transmitting by the network device a physical downlink control channel used for the terminal equipment to receive a physical downlink shared channel where system information is located in the second search space.

47. The method according to supplement 45 or 46, wherein transmitting by the network device a PDCCH to a reduced capability terminal equipment at a first time, and transmitting by the network device a PDCCH to a non-reduced capability terminal equipment at a second time, the first time and the second time being not overlapped.

48. A data transmission method, applicable to a network device, the method comprising:

transmitting third indication information by the network device, the third indication information being used for indicating second configuration information of a second control resource set of a terminal equipment and/or being used for indicating fourth configuration information of a second search space of a terminal equipment; and

on resources of the second control resource set and/or in the second search space, transmitting by the network device a physical downlink control channel used for the terminal equipment to receive a physical downlink shared channel where system information is located.

49. A data transmission method, applicable to a network device, the method comprising: transmitting, by the network device to a terminal equipment in a bandwidth less than or equal to a first value, a physical downlink control channel used for the terminal equipment to receive a physical downlink shared channel where system information is located.

50. The method according to supplement 49, wherein the terminal equipment is a reduced capability terminal equipment.

51. A data transmission method, applicable to a network device, the method comprising:

transmitting fourth indication information and fifth indication information by the network device to a terminal equipment, the fourth indication information being used to indicate first related information of a first initial bandwidth part (BWP), and the fifth indication information being used to indicate second related information of a second initial bandwidth part (BWP); and

transmitting a downlink channel and/or signal by the network device in the second initial bandwidth part indicated by the fifth indication information.

52. A data transmission method, applicable to a network device, the method comprising:

transmitting fourth indication information by the network device to a terminal equipment, the fourth indication information being used to indicate first related information of a first initial bandwidth part (BWP); and

transmitting a downlink channel and/or signal by the network device in a bandwidth of a control resource set after transmitting a radio resource control related message.

53. A data transmission method, applicable to a network device, the method comprising:

transmitting fourth indication information by the network device to a terminal equipment, the fourth indication information being used to indicate first related information of a first initial bandwidth part (BWP) and being used to determine second related information of a second initial bandwidth part (BWP) of the terminal equipment; and

transmitting a downlink channel and/or signal by the network device to the terminal equipment in the second initial bandwidth part.

54. A terminal equipment, including a memory and a processor, the memory storing a computer program, and the processor being configured to execute the computer program to carry out the data reception method as described in any one of supplements 1-44.

55. A network device, including a memory and a processor, the memory storing a computer program, and the processor being configured to execute the computer program to carry out the data transmission method as described in any one of supplements 45-53.

56. A data reception apparatus, applicable to a terminal equipment, the apparatus comprising:

a first receiving unit configured to receive first indication information, the first indication information being used for indicating first configuration information of a first control resource set;

a first determining unit configured to determine second configuration information of a second control resource set of the terminal equipment according to the first indication information or a synchronization signal block (SSB) to which the first control resource set corresponds; and

a first monitoring unit configured to, on resources of the second control resource set, monitor a physical downlink control channel used for receiving a physical downlink shared channel where system information is located.

57. The apparatus according to supplement 56, wherein the first determining unit determines a frequency-domain starting or ending or central location of the first control resource set according to the first indication information, and takes the frequency-domain starting or ending or central location of the first control resource set as a frequency-domain starting, or ending or central location of the second control resource set, or performs offset on the frequency-domain starting or ending or central location of the first control resource set by a second offset value and takes the location after performing offset as a frequency-domain starting or ending or central location of the second control resource set.

58. The apparatus according to supplement 56, wherein when the first indication information is an index, the first determining unit takes an index obtained by performing a third offset value plus on an index of the first control resource set as an index of the second control resource set.

59. The apparatus according to supplement 56, wherein the first determining unit takes a frequency-domain starting or ending or central location of the synchronization signal block (SSB) to which the first control resource set corresponds as a frequency-domain starting and/or ending and/or central location of the second control resource set, or performs offset on a frequency-domain starting and/or ending and/or central location of the synchronization signal block (SSB) to which the first control resource set corresponds by a fourth offset value and takes the location after performing offset as a frequency-domain starting and/or ending and/or central location of the second control resource set.

60. The apparatus according to any one of supplements 56-59, wherein the first determining unit is further configured to determine that a time-domain length of the second control resource set is less than or equal to a time-domain length of the first control resource set,

or a time-domain length of the second control resource set is equal to a time-domain length to which the index of the second control resource set corresponds,

or a frequency-domain bandwidth of the second control resource set is predefined or equal to a bandwidth to which the index of the second control resource set corresponds.

61. The apparatus according to any one of supplements 56-60, wherein the first indication information is contained in a master information block (MIB).

62. The apparatus according to any one of supplements 56-61, wherein the first configuration information comprises at least one of a pattern multiplexed by the synchronization signal block and the first control resource set, frequency-domain bandwidth information, time-domain length information, and the first offset value of the frequency-domain between the first control resource set and the synchronization signal block.

63. The apparatus according to any one of supplements 56-62, wherein the terminal equipment is a reduced capability terminal equipment.

64. The apparatus according to any one of supplements 56-63, wherein the first control resource set and the second control resource set are control resource set 0 (coreset 0).

65. The apparatus according to any one of supplements 56-64, wherein the system information is of system information block type 1 (SIB1).

66. A data reception apparatus, applicable to a terminal equipment, the apparatus comprising:

a second receiving unit configured to receive second indication information, the second indication information being used for indicating third configuration information of a first search space;

a second determining unit configured to determine fourth configuration information of a second search space of the terminal equipment according to the second indication information; and

a second monitoring unit configured to monitor in the second search space a physical downlink control channel used for receiving a physical downlink shared channel where system information is located.

67. The apparatus according to supplement 66, wherein when the second indication information is an index, the second determining unit takes an index obtained by performing a fifth offset value plus on the index indicated by the second indication information as the index of the second search space, or, determines the index of the second search space according to the index of the first search space and a predetermined relationship between the index of first search space and the index of second search space.

68. The apparatus according to supplement 66, wherein an occasion of monitoring the PDCCH in the second search space does not overlap with an occasion of monitoring the PDCCH in the first search space.

69. The apparatus according to supplement 68, wherein the second determining unit takes the index indicated by the second indication information as the index of the second search space and calculates a starting slot index monitoring a PDCCH in the second search space according to third configuration information to which an index indicated by the second indication information corresponds, performs offset on the starting slot index by a sixth offset value, and takes the index after performing offset as the starting slot index monitoring a PDCCH in the second search space;

or,

takes the index indicated by the second indication information as the index of the second search space and calculates a second system frame number of a radio frame where a slot monitoring a PDCCH is located in the second search space according to third configuration information to which an index indicated by the second indication information corresponds, the second system frame number not overlapping with a first system frame number of a radio frame where a slot monitoring a PDCCH is located in the first search space;

or, calculates a first PDCCH monitoring occasion in the first search space according to third configuration information to which an index indicated by the second indication information corresponds, and third configuration information indicated by an index of a search space to which a selected second PDCCH monitoring occasion not overlapping with the first PDCCH monitoring occasion corresponds is taken as fourth configuration information of the second search space.

70. The apparatus according to any one of supplements 66-69, wherein the second indication information is contained in a master information block (MIB).

71. The apparatus according to any one of supplements 66-70, wherein the terminal equipment is a reduced capability terminal equipment.

72. The apparatus according to any one of supplements 66-71, wherein the first search space and the second search space are search space 0 (SS 0).

73. The apparatus according to any one of supplements 66-72, wherein the system information is system information block type 1 (SIB1).

74. A data reception apparatus, applicable to a terminal equipment, the apparatus comprising:

a third receiving unit configured to receive third indication information, the third indication information being used for indicating second configuration information of a second control resource set of the terminal equipment and/or indicating fourth configuration information of a second search space of the terminal equipment; and

a third monitoring unit configured to, on resources of the second control resource set and/or in the second search space, monitor physical downlink control channels used for receiving physical downlink shared channels where system information is located.

75. The apparatus according to supplement 74, wherein the third indication information is contained in a master information block (MIB).

76. The apparatus according to supplement 74, wherein the third indication information is an information element with 1 bit.

77. The apparatus according to supplement 74, wherein the apparatus further includes:

a third determining unit configured to determine the second configuration information of the second control resource set and/or the fourth configuration information indicating the second search space according to the third indication information and a correspondence between the third indication information and the second configuration information of the second control resource set and/or the fourth configuration information indicating the second search space of the terminal equipment.

78. The apparatus according to any one of supplements 74-77, wherein the terminal equipment is a reduced capability terminal equipment.

79. The apparatus according to any one of supplements 74-78, wherein the second search space is search space 0 (SS 0), the second control resource set is control resource set 0.

80. The apparatus according to any one of supplements 74-79, wherein the system information is system information block type 1 (SIB1).

81. A data reception apparatus, applicable to a terminal equipment, the apparatus comprising:

a fourth determining unit configured to determine a bandwidth of a second control resource set of the terminal equipment, the bandwidth being less than or equal to a first value; and

a fourth monitoring unit configured to monitor in the bandwidth of the second search space a physical downlink control channel used for receiving a physical downlink shared channel where system information is located.

82. The apparatus according to supplement 81, wherein the first value is related to a maximum bandwidth capability of the terminal equipment.

83. The apparatus according to supplement 81, wherein a frequency-domain location of the physical downlink data channel indicated by the physical downlink control channel is within the bandwidth of the second control resource set.

84. The apparatus according to any one of supplements 81-83, wherein the terminal equipment is a reduced capability terminal equipment.

85. The apparatus according to any one of supplements 81-84, wherein the second control resource set is control resource set 0 (coreset 0).

86. The apparatus according to any one of supplements 81-85, wherein the system information is system information block type 1 (SIB1).

87. A data reception apparatus, applicable to a terminal equipment, the apparatus comprising:

a fifth determining unit configured to receive fourth indication information and fifth indication information transmitted by a network device, the fourth indication information being used to indicate first related information of a first initial bandwidth part (BWP), and the fifth indication information being used to indicate second related information of a second initial bandwidth part (BWP); and

a fourth receiving unit configured to receive a downlink channel and/or signal in the second initial bandwidth part indicated by the fifth indication information.

88. The apparatus according to supplement 87, wherein the fourth indication information is contained in a system information block to indicate a location and bandwidth of the first initial bandwidth part (BWP).

89. The apparatus according to supplement 87 or 88, wherein the fifth indication information is contained in a system information block to indicate second related information of a second initial bandwidth part (BWP) of a reduced capability terminal equipment, the second related information comprising an offset and/or a location and/or a bandwidth; wherein the offset indicates an offset between a starting or ending or central location of the second initial bandwidth part and a starting or ending or central location of the first initial bandwidth part.

90. The apparatus according to supplement 87 or 88, wherein the fifth indication information is contained in a radio resource control related message.

91. The apparatus according to any one of supplements 87-90, wherein the second initial bandwidth part covers a control resource set of the terminal equipment.

92. A data reception apparatus, applicable to a terminal equipment, the apparatus comprising:

a fifth receiving unit configured to receive fourth indication information transmitted by a network device, the fourth indication information being used to indicate first related information of a first initial bandwidth part (BWP); and

a sixth receiving unit configured to receive a downlink channel and/or signal in a bandwidth of a control resource set after receiving a radio resource control related message.

93. The apparatus according to supplement 92, wherein the fourth indication information is contained in a system information block (such as SIB1) to indicate a location and bandwidth of the first initial bandwidth part (BWP).

94. A data reception apparatus, applicable to a terminal equipment, the apparatus comprising:

a seventh receiving unit configured to receive fourth indication information transmitted by a network device, the fourth indication information being used to indicate first related information of a first initial bandwidth part (BWP);

a sixth determining unit configured to determine second related information of a second initial bandwidth part (BWP) of the terminal equipment according to the fourth indication information; and

an eighth receiving unit configured to receive a downlink channel and/or signal in the second initial bandwidth part.

95. The apparatus according to supplement 94, wherein the sixth determining unit takes an location obtained by performing offset on a frequency-domain starting or ending or central location of the first initial bandwidth part by an eighth offset value as a frequency-domain starting or ending or central location of the second initial bandwidth part.

96. The apparatus according to supplement 94 or 95, wherein the second initial bandwidth part covers the control resource set of the terminal equipment.

97. The apparatus according to any one of supplements 91-93 and 96, wherein the control resource set is a control resource set 0, and in a bandwidth of the control resource set 0, the terminal equipment monitors a physical downlink control channel used for receiving a physical downlink shared channel where system information is located.

98. The apparatus according to supplement 88 or 89 or 93 or 97, wherein the system information is system information block type 1.

99. The apparatus according to any one of supplements 87-98, wherein the terminal equipment is a reduced capability terminal equipment.

100. A data transmission apparatus, applicable to a network device, the apparatus comprising:

a first transmitting unit configured to transmit first indication information, the first indication information being used for indicating first configuration information of a first control resource set; the first indication information or a synchronization signal block (SSB) to which the first control resource set corresponds being used for determining second configuration information of a second control resource set of the terminal equipment;

a second transmitting unit configured to, on a resource of the second control resource set, transmit a physical downlink control channel used for the terminal equipment to receive a physical downlink shared channel where system information is located.

101. A data transmission apparatus, applicable to a network device, the apparatus comprising:

a third transmitting unit configured to transmit second indication information, the second indication information being used to indicate third configuration information of a first search space, and the second indication information being used to determine fourth configuration information of a second search space of a terminal equipment; and

a fourth transmitting unit configured to transmit a physical downlink control channel used for the terminal equipment to receive a physical downlink shared channel where system information is located in the second search space.

102. The apparatus according to supplement 100 or 101, wherein the second transmitting unit or the fourth transmitting unit transmits a PDCCH to a reduced capability terminal equipment at a first time, and transmits a PDCCH to a non-reduced capability terminal equipment at a second time, the first time and the second time being not overlapped.

103. A data transmission apparatus, applicable to a network device, the apparatus comprising:

a fifth transmitting unit configured to transmit third indication information by the network device, the third indication information being used for indicating second configuration information of a second control resource set of a terminal equipment and/or being used for indicating fourth configuration information of a second search space of a terminal equipment; and

a sixth transmitting unit configured to, on resources of the second control resource set and/or in the second search space, transmit a physical downlink control channel used for the terminal equipment to receive a physical downlink shared channel where system information is located.

104. A data transmission apparatus, applicable to a network device, the apparatus comprising:

a seventh transmitting unit configured to transmit to a terminal equipment in a bandwidth less than or equal to a first value, a physical downlink control channel used for the terminal equipment to receive a physical downlink shared channel where system information is located.

105. The apparatus according to supplement 104, wherein the terminal equipment is a reduced capability terminal equipment.

106. A data transmission apparatus, applicable to a network device, the apparatus comprising:

an eighth transmitting unit configured to transmit fourth indication information and fifth indication information to a terminal equipment, the fourth indication information being used to indicate first related information of a first initial bandwidth part (BWP), and the fifth indication information being used to indicate second related information of a second initial bandwidth part (BWP); and

a ninth transmitting unit configured to transmit a downlink channel and/or signal in the second initial bandwidth part indicated by the fifth indication information.

107. A data transmission apparatus, applicable to a network device, the apparatus comprising:

a tenth transmitting unit configured to transmit fourth indication information to a terminal equipment, the fourth indication information being used to indicate first related information of a first initial bandwidth part (BWP); and

an eleventh transmitting unit configured to transmit a downlink channel and/or signal in a bandwidth of a control resource set after transmitting a radio resource control related message.

108. A data transmission apparatus, applicable to a network device, the apparatus comprising:

a twelfth transmitting unit configured to transmit fourth indication information to a terminal equipment, the fourth indication information being used to indicate first related information of a first initial bandwidth part (BWP) and being used to determine second related information of a second initial bandwidth part (BWP) of the terminal equipment; and

a thirteenth transmitting unit configured to transmit a downlink channel and/or signal to the terminal equipment in the second initial bandwidth part.

What is claimed is:

1. An apparatus, applicable to a terminal equipment, the apparatus comprising:
a receiver configured to receive first indication information, the first indication information being used for indicating first configuration information of a first control resource set;
a processor configured to:
determine second configuration information of a second control resource set of the terminal equipment according to the first indication information or a synchronization signal block (SSB) to which the first control resource set corresponds; and
monitor, on resources of the second control resource set, monitor a physical downlink control channel used for receiving a physical downlink shared channel where system information is located.

2. The apparatus according to claim 1, wherein the processor determines a frequency-domain starting or ending or central location of the first control resource set according to the first indication information, and takes the frequency-domain starting or ending or central location of the first control resource set as a frequency-domain starting or ending or central location of the second control resource set, or performs offset on the starting or ending or central location of the frequency-domain of the first control resource set by a second offset value and takes the location after performing offset as a frequency-domain starting, or ending or central location of the second control resource set.

3. The apparatus according to claim 1, wherein when the first indication information is an index, the processor takes an index obtained by performing a third offset value plus on an index of the first control resource set as an index of the second control resource set.

4. The apparatus according to claim 1, wherein the processor takes a frequency-domain starting or ending or central location of the synchronization signal block (SSB) to which the first control resource set corresponds as a starting and/or ending and/or central location of a frequency-domain of the second control resource set, or performs offset on a starting and/or ending and/or central location of a frequency-domain of the synchronization signal block (SSB) to which the first control resource set corresponds by a fourth offset value and takes the location after performing the offset as a starting and/or ending and/or central location of a frequency-domain of the second control resource set.

5. The apparatus according to claim 1, wherein the processor is further configured to determine that a time-domain length of the second control resource set is less than or equal to a time-domain length of the first control resource set,
or a time-domain length of the second control resource set is equal to a time-domain length to which the index of the second control resource set corresponds,
or a frequency-domain bandwidth of the second control resource set is predefined or equal to a bandwidth to which the index of the second control resource set corresponds.

6. The apparatus according to claim 1, wherein the first indication information is contained in a master information block (MIB).

7. The apparatus according to claim 1, wherein the first configuration information comprises at least one of a pattern multiplexed by the synchronization signal block and the first control resource set, frequency-domain bandwidth information, time-domain length information, and the first offset value of the frequency-domain between the first control resource set and the synchronization signal block.

8. The apparatus according to claim 1, wherein the terminal equipment is a reduced capability terminal equipment.

9. The apparatus according to claim 1, wherein the first control resource set and the second control resource set are control resource set 0 (CORESET 0).

10. The apparatus according to claim 1, wherein the system information is of system information block type 1 (SIB1).

11. An apparatus, applicable to a terminal equipment, the apparatus comprising:
a memory; and
a processor coupled to the memory and configured to:
receive fourth indication information and fifth indication information transmitted by a network device, the fourth indication information being used to indicate first related information of a first initial bandwidth part (BWP), and the fifth indication information being used to indicate second related information of a second initial bandwidth part (BWP), and
receive a downlink channel and/or signal in the second initial bandwidth part indicated by the fifth indication information.

12. The apparatus according to claim 11, wherein the fourth indication information is contained in a system information block to indicate a location and bandwidth of the first initial bandwidth part (BWP).

13. The apparatus according to claim 11, wherein the fifth indication information is contained in a system information block to indicate second related information of a second initial bandwidth part (BWP) of a reduced capability terminal equipment, the second related information comprising a location and/or a bandwidth.

14. The apparatus according to claim 11, wherein the fifth indication information is contained in a radio resource control related message.

15. The apparatus according to claim 11, wherein the second initial bandwidth part covers a control resource set of the terminal equipment.

16. The apparatus according to claim 11, wherein the processor configured to receive a downlink channel and/or signal in the second initial bandwidth part after receiving a Radio Resource Control (RRC) message.

17. An apparatus, applicable to a network device, the apparatus comprising:
a memory; and
a processor coupled to the memory and configured to:
transmit fourth indication information and fifth indication information to a terminal equipment, the fourth indication information being used to indicate first related information of a first initial bandwidth part (BWP), and the fifth indication information being used to indicate second related information of a second initial bandwidth part (BWP), and
transmit a downlink channel and/or signal in the second initial bandwidth part indicated by the fifth indication information.

18. The apparatus according to claim 17, wherein the fourth indication information is contained in a system information block to indicate a position and bandwidth of the first initial bandwidth part (BWP).

19. The apparatus according to claim 17, wherein the fifth indication information is contained in a system information block to indicate second related information of a second initial bandwidth part (BWP) of a reduced capability terminal equipment, the second related information comprising a position and/or a bandwidth.

20. The apparatus according to claim 17, wherein the second initial bandwidth part covers a control resource set of the terminal equipment, and
the processor is further configured to receive a downlink channel and/or signal in the second initial bandwidth part after receiving a Radio Resource Control (RRC) message.
